(19) United States
(12) Patent Application Publication
(10) Pub. No.: US 2020/0367147 A1
(43) Pub. Date: Nov. 19, 2020

(54) Access Control In A Wireless Communication Network

(71) Applicant: Telefonaktiebolaget LM Ericsson (publ), Stockholm (SE)

(72) Inventors: Andreas Höglund, Solna (SE); Johan Bergman, Stockholm (SE); Magnus Karlsson, Lund (SE); Olof Liberg, Stockholm (SE); Yutao Sui, Solna (SE); Emre Yavuz, Stockholm (SE)

(21) Appl. No.: 16/345,794

(22) PCT Filed: Dec. 11, 2018
(86) PCT No.: PCT/SE2018/051272

§ 371 Date: Apr. 29, 2019

Related U.S. Application Data
(60) Provisional application No. 62/597,410, filed on Dec. 11, 2017.

(51) Int. Cl. H04W 48/12; H04W 48/16; H04W 76/27; H04W 24/08; H04W 8/24

(52) U.S. Cl. CPC H04W 48/12; H04W 48/16; H04W 84/042; H04W 24/08; H04W 8/245; H04W 76/27

(57) ABSTRACT

A wireless device (14) is configured for use in a wireless communication network (10). The wireless device (14) is configured to receive, from the wireless communication network (10), information (22) that configures the wireless device (14) to restrict uplink access by the wireless device (14) to the wireless communication network (10), unless and until the wireless device (14) is configured otherwise by other information from the wireless communication network (10). The information (22) may for example indicate that uplink access by the wireless device (14) to the wireless communication network (10) is not allowed. Regardless, the wireless device (14) is configured to restrict uplink access by the wireless device (14) to the wireless communication network (10) in accordance with the received information (22).

### BACKGROUND

Machine type communication (MTC) is about providing connectivity for devices which communicate without human interaction. That is, providing cellular connectivity for the Internet of things (IoT). It is predicted to increase the number of connections exponentially more than the increase of human subscriptions and the number of fixed connections. This is sometimes referred to as ‘the networked society’. Because of the different nature, the requirements are also different from those of human-oriented smart phone traffic. MTC devices need to have low cost, which is achieved by low user equipment (UE) complexity and reduced capabilities (e.g., one receiving antenna, a narrow device bandwidth smaller than the system bandwidth, etc.). The power consumption should further be low in order to prolong battery life such that interactive battery charging is not required, preferably throughout the life span of the device. To be able to reach devices in challenging location, e.g. basements, It is desirable to enhance coverage in comparison to normal systems.

In Rel-13 three different radio access technologies were introduced for this purpose in 3GPP: Long Term Evolution MTC (LTE-MTC), Narrowband IoT (NB-IoT), and Extended Coverage Global System for Mobile communication (EC-GSM). In addition to 3GPP technologies, there are a number of IoT solutions designed for unlicensed band operation. These include LoRa, Sigfox, and Ingenu.

No matter the particular radio access technology, though, MTC is designed to provide a very long battery life for devices. Devices may for instance be targeted as having a battery life of 10 years. Although this avoids frequent battery charging or replacement, it may threaten system performance over the long-term.

### SUMMARY

Some embodiments herein include a method performed by a wireless device configured for use in a wireless communication network. The method includes receiving, from the wireless communication network, information that configures the wireless device to restrict uplink access by the wireless device to the wireless communication network, unless and until the wireless device is configured otherwise by other information from the wireless communication network. The method also includes restricting uplink access by the wireless device to the wireless communication network in accordance with the received information.

In some embodiments, the information is received via dedicated signaling.

In some embodiments, the method also comprises attaching to the wireless communication network and, while the wireless device is attached to the wireless communication network and configured to restrict uplink access to the wireless communication network, monitoring for a page from the wireless communication network and/or receiving a downlink transmission from the wireless communication network.

In some embodiments, the method also comprises, while the wireless device is configured to restrict uplink access to the wireless communication network, receiving an update to an application of the wireless communication device or an update to firmware of the wireless communication device.

Some embodiments also include a method performed by a network node configured for use in a wireless communication network. The method comprises transmitting, from the wireless communication network, information that configures a wireless device to restrict uplink access by the wireless device to the wireless communication network, unless and until the wireless device is configured otherwise by other information from the wireless communication network.

In some embodiments, the information is transmitted via dedicated signaling.

In some embodiments, the method also comprises, while the wireless device is attached to the wireless communication network and configured to restrict access to the wireless communication network, transmitting a page from the wireless communication network to the wireless device and/or transmitting a downlink transmission from the wireless communication network to the wireless device.

In some embodiments, the method further comprises, while the wireless device is configured to restrict access to the wireless communication network, transmitting an update to an application of the wireless communication device or an update to firmware of the wireless communication device.

In some embodiments, the method further comprises determining to restrict access by the wireless device to the wireless communication network and transmitting the information responsive to the determining. For example, in some embodiments, said determining is based on one or more of: the wireless device not having successfully set up a connection or attached to the wireless communication network for a certain period of time or over a certain number of attempts; the wireless device engaging in one or more actions indicating misconduct by the wireless device; receiving from the wireless device signalling from a certain application; or not having received any application layer signalling from the wireless device for a certain time period.

In any of the above embodiments, the information indicates uplink access by the wireless device to the wireless communication network is not allowed.

In any of the above embodiments, the information indicates the wireless device is barred from uplink access to the wireless communication network.

In any of the above embodiments, the information configures the wireless device to restrict uplink access to the wireless communication network, but not downlink access to the wireless communication network.

In any of the above embodiments, the other information includes a page from the wireless communication network.

In any of the above embodiments, the information configures the wireless device to restrict uplink access to the wireless communication network by configuring the wireless device to belong to a certain access class.

In any of the above embodiments, the information assigns the wireless device to a category of wireless devices that have become obsolete, configures a capability of the wireless device, assigns the wireless device a new home public land mobile network to which access is restricted, or comprises subscription information that configures an integrated circuit card or subscriber identity module of the wireless device such that the wireless device restricts uplink access to the wireless communication network.

In any of the above embodiments, as configured according to the information the wireless device is not allowed to: initiate establishment or resumption of a radio resource control, RRC, connection to the wireless communication network; or initiate any procedure that triggers establishment or resumption of an RRC connection to the wireless communication network.

In any of the above embodiments, the wireless device is a machine type communication (MTC) device or a narrowband internet of things (NB-IoT) device.

Embodiments herein also include corresponding apparatus, computer programs, and carriers. For example, embodiments herein include a wireless device configured for use in a wireless communication network. The wireless device is configured to receive, from the wireless communication network, information that configures the wireless device to restrict uplink access by the wireless device to the wireless communication network, unless and until the wireless device is configured otherwise by other information from the wireless communication network. The wireless device is also configured to restrict uplink access by the wireless device to the wireless communication network in accordance with the received information.

Embodiments also include a network node configured for use in a wireless communication network. The method comprises transmitting, from the wireless communication network, information that configures a wireless device to restrict uplink access by the wireless device to the wireless communication network, unless and until the wireless device is configured otherwise by other information from the wireless communication network.

### BRIEF DESCRIPTION OF THE DRAWINGS

FIG. 1 is a block diagram of a wireless communication network according to some embodiments.

FIG. 2 is a logic flow diagram of a method performed by a wireless device according to some embodiments.

FIG. 3 is a logic flow diagram of a method performed by a network node according to some embodiments.

FIG. 4 is a block diagram of a wireless device according to some embodiments.

FIG. 5 is a block diagram of a wireless device according to other embodiments.

FIG. 6 is a block diagram of a network node according to some embodiments.

FIG. 7 is a block diagram of a network node according to other embodiments.

FIG. 8 is a block diagram of a typical NPRACH configuration with three resources for Coverage level 0 (CE0), 1 (CE1) and 2 (CE2).

FIG. 9 is a block diagram of a wireless communication network according to some embodiments.

FIG. 10 is a block diagram of a user equipment according to some embodiments.

FIG. 11 is a block diagram of a virtualization environment according to some embodiments.

FIG. 12 is a block diagram of a communication network with a host computer according to some embodiments.

FIG. 13 is a block diagram of a host computer according to some embodiments.

FIG. 14 is a flowchart illustrating a method implemented in a communication system, in accordance with one embodiment.

FIG. 15 is a flowchart illustrating a method implemented in a communication system, in accordance with one embodiment.

FIG. 16 is a flowchart illustrating a method implemented in a communication system, in accordance with one embodiment.

FIG. 17 is a flowchart illustrating a method implemented in a communication system, in accordance with one embodiment.

### DETAILED DESCRIPTION

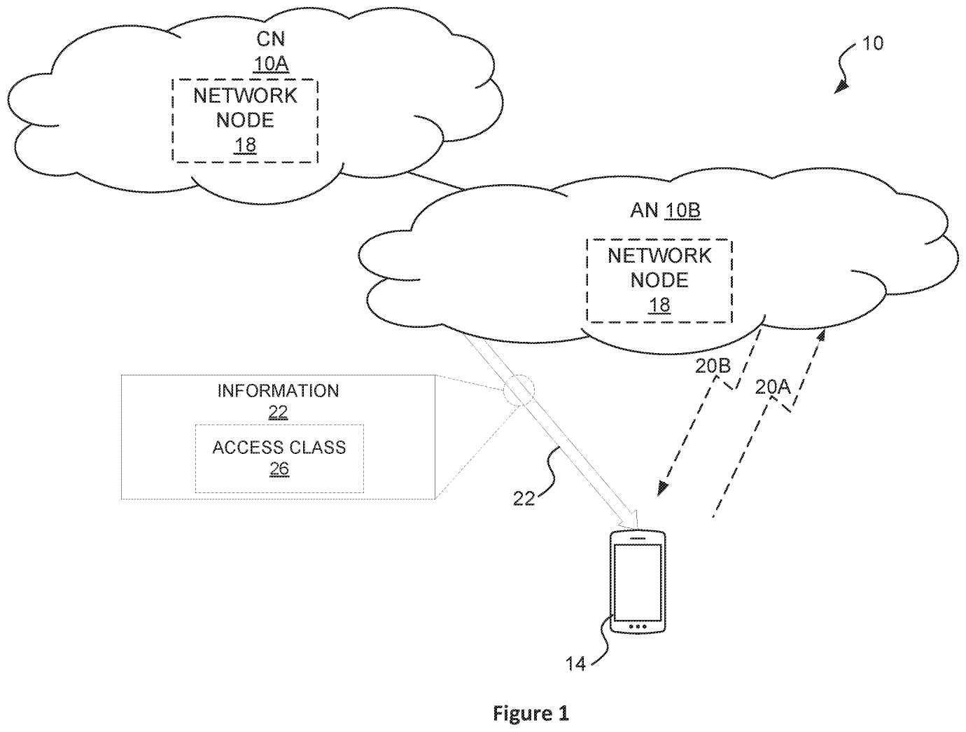

FIG. 1 shows a wireless communication network 10 (e.g., a narrowband internet-of-things (NB-IoT), enhanced machine-type communication (eMTC), or 5G network) according to some embodiments. The network 10 includes a core network (CN) 10A and an access network (AN) 10B. The AN 10B includes one or more radio network nodes (e.g., one or more base stations) for providing radio access to wireless communication devices 14 (or simply “wireless device”), one of which is shown. The radio access may be uplink access 20A and/or downlink access 20B. Via this radio access, a wireless device 14 connects to the CN 10A, which in turn may provide the wireless device 14 with access to one or more external networks, such as the Internet. The CN 10A for example may include different CN nodes.

In some embodiments, the wireless device 14 is a machine type communication (MTC) device (e.g., an LTE-MTC device), a narrowband internet of things (NB-IoT) device, or an EC-GSM device. In these and other embodiments, then, the wireless device 14 may be designed to have a very long battery life, e.g., on the order of 10 years, and/or may be deployed in a manner that makes its retrieval or disablement difficult. In this case, the wireless device 14 may remain in the network 10 long after the device 14 has served its purpose and has become obsolete, which may in turn threaten to degrade performance of the network 10 if the device 14 continues to access the network 10 (e.g., by transmitting access requests in the uplink).

To address this and/or other problems, the network 10 includes a network node 18 in the CN 10A and/or AN 10B that manages or otherwise controls access by the wireless device 14 to the network 10. When included in the CN 10A, the network node 18 may be for instance a mobility management entity (MME), a node implementing a session management function (SMF), or a home subscriber server (HSS). When included in the AN 10B, the network node 18 may be a base station or other radio network node.

The network 10 (e.g., network node 18) in particular may transmit information 22 to the wireless device 14 that configures the wireless device 14 to restrict access by the wireless device 14 to the wireless communication network 10. Here, that access by the wireless device to the wireless communication network 10 is restricted means that such access is prevented or prohibited. The information 22 thereby configures the wireless device 14 in such a way that the wireless device 14 prevents itself from or otherwise refrains from accessing the wireless communication network 10.

In one or more embodiments, the information 22 configures the wireless device 14 to restrict at least uplink access to the network 10. When configured in this way, the wireless device 14 in some embodiments may not be allowed to initiate establishment or resumption of a radio resource control, RRC, connection to the wireless communication network, or initiate any procedure that triggers establishment or resumption of an RRC connection to the wireless communication network.

In some embodiments, the information 22 configures the wireless device 14 to restrict both downlink and uplink access to the wireless communication network 10, i.e., to restrict access over both the uplink access 20A and the downlink access 20B. So configured, the wireless device 14 may refrain from receiving downlink transmissions via downlink access 20A as well as from performing uplink transmissions via uplink access 20B. The information 22 may thereby effectively shut down the device 14 from a radio point-of-view for both uplink transmission and downlink transmission. In some embodiments, then, the information 22 may effectively configure the wireless device 14 to restrict access to the wireless communication network 10 permanently, e.g., since the device 14 becomes unable to receive any other information from the network 10 that would configure the wireless device 14 to no longer restrict such access.

In other embodiments, by contrast, the information 22 configures the wireless device 14 to restrict uplink access to the wireless communication network 10, but not downlink access, i.e., to restrict access over uplink access 20A, but not over downlink access 20B. Configured in this way, the wireless device 14 may refrain from performing uplink transmissions via uplink access 20B, but may still receive downlink transmissions via downlink access 20A. For example, while the wireless device 14 is configured to restrict uplink access, the wireless device 14 may not perform any uplink transmission but may still nonetheless monitor for a page from the network 10 or otherwise receive a downlink transmission from the network 10. Alternatively or additionally, the device 14 may receive an update to an application of the device 14 and/or receive an update to firmware of the device 14. For example, where the device 14 is an MTC device, NB-IoT device, or other device at risk for remaining in the network 10 despite becoming obsolete, this may allow the device 14 to be reached by the network 10 and configured to serve a new purpose. This may alternatively or additionally allow the device 14 to receive from the network 10 other information that configures the device 14 to no longer restrict access to the network 10.

In these and other embodiments, then, the information 22 may configure the wireless device 14 to restrict access to the network 10 indefinitely (e.g., until further notice or otherwise configured). This may mean for instance that the duration of time for which access to the network 10 is restricted continues indefinitely, with no component of the duration being definite or determinable. The duration may continue for instance for an unknown and indeterminant amount of time until the device 14 receives other information from the network 10 that configures the device 14 to no longer restrict such access. Accordingly, in alternative or additional embodiments, the information 22 may configure the wireless device to restrict access to the wireless communication network 10, unless and until the wireless device 14 is configured otherwise by other information from the wireless communication network 10. Where for instance the information 22 that initially configures the wireless device 14 to restrict its access is information that indicates the device 14 is not allowed to access the network 10, the other information may be information that indicates the device 14 is allowed to access the network 10. Or, where the information 22 configures the wireless device 14 to restrict uplink access, the other information may be a page for the wireless device, e.g., such that the wireless device 14 is effectively configured to restrict mobile-originated uplink access, but not network-initiated uplink access.

Regardless, conditioning access by the device 14 on receipt of other information from the network 10 in this way, and/or otherwise restricting access indefinitely, differs from traditional access barring, e.g., that may be performed upon network congestion. Such traditional access barring in this regard may temporarily prevent a device from accessing the network (e.g., by transmitting an access request), but such access barring inevitably expires after a certain time period defined at the start of barring. This time period may be a defined barring duration, or may depend on both a defined barring duration as well as a random number, e.g., such that the actual barring time is within a defined range of times. In either case, the barring duration becomes definite at the start of the barring. Such traditional barring accordingly does not prevent the device from accessing the network again at a later point in time (e.g., by transmitting another access request) once the barring duration expires.

Restricting access according to some embodiments herein may also differ from traditional access barring in that it may be applied more selectively to certain wireless devices, e.g., that have become obsolete. Indeed, traditional access barring applies to all access classes regardless of whether a device has become obsolete. In fact, in some embodiments, the information 22 herein may be transmitted to the device 14 using dedicated signaling.

Some embodiments herein therefore prove particularly useful for ensuring that obsolete devices (e.g., obsolete MTC or NB-IoT devices) do not degenerate network performance, e.g., by access attempts and other uplink transmissions. Alternatively or additionally, some embodiments ensure that devices are still reachable in the downlink (no disadvantage for the radio performance) such that they can later reached, e.g. for a firmware update or application layer changes to serve a new purpose.

The information 22 may configure the wireless device 14 to restrict access to the network 10 in any number of ways. In some embodiments, as shown in FIG. 1 for example, the information 22 may configure the wireless device 14 to belong to a certain access class 26. When a member of the certain access class, the device 14 may be configured to restrict its access as described above, e.g., unless and until the device 14 is configured to belong to a different access class. In other embodiments, by contrast, the information 22 may assign the wireless device 14 to a category of wireless devices that have become obsolete, configures a capability of the wireless device 14, assigns the wireless device 14 a new home public land mobile network to which access is restricted, or comprises subscription information that configures an integrated circuit card or subscriber identity module of the wireless device 14 such that the wireless device 14 restricts uplink access to the wireless communication network 10.

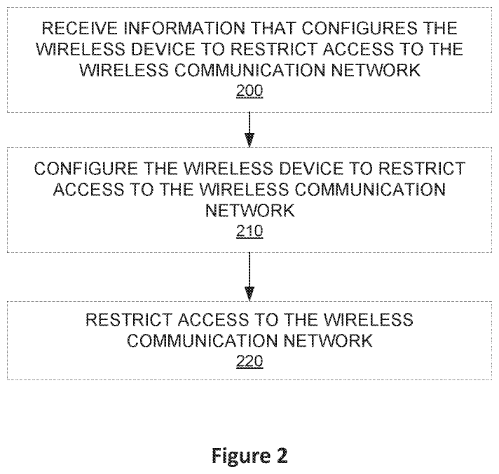

In view of the above modifications and variations, FIG. 2 depicts a method performed by a wireless device 14 in accordance with particular embodiments. The method may include receiving from the wireless communication network 10 (e.g., network node 18) information 22 that configures the wireless device 14 to restrict access by the wireless device 14 to the wireless communication network 10 (Block 200). In some embodiments, for example, the information 22 may configure the wireless device 14 to restrict uplink access by the wireless device 14 to the wireless communication network 10, e.g., unless and until the wireless device 14 is configured otherwise by other information from the wireless communication network 10.

In some embodiments, the method additionally or alternatively comprises configuring the wireless device 14 to restrict access to the wireless communication network 10, e.g., according to the received information 22 (Block 210). In some embodiments, the method additionally or alternatively comprises restricting access to the wireless communication network 10 (Block 220). This may include for instance refraining from accessing the network 10, e.g., in the uplink.

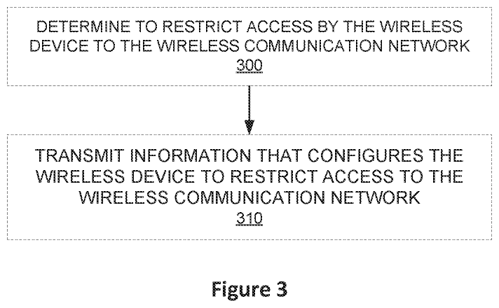

FIG. 3 depicts a method performed by a network node 18 in accordance with other particular embodiments. The method as shown may include transmitting information 22 that configures the wireless device 14 to restrict access by the wireless device 14 to the wireless communication network 10 (Block 300). In some embodiments, for example, the information 22 may configure the wireless device 14 to restrict uplink access by the wireless device 14 to the wireless communication network 10, e.g., unless and until the wireless device 14 is configured otherwise by other information from the wireless communication network 10.

The method may also include determining to restrict access by the wireless device 14 to the wireless communication network 10 (Block 310). For example, this determination may be based on the wireless device 14 not having successfully set up a connection or attached to the wireless communication network 10 for a certain period of time or over a certain number of attempts, the wireless device 14 engaging in one or more actions indicating misconduct by the wireless device 14, receiving from the wireless device 14 signalling from a certain application, and/or not having received any application layer signalling from the wireless device 14 for a certain time period. At least some of these conditions may prove particularly useful for differentiating obsolete devices.

Note that the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

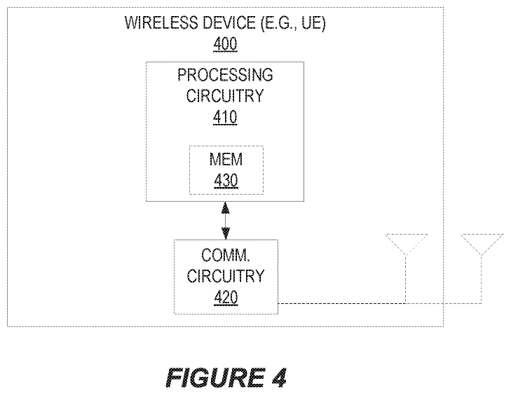

FIG. 4 for example illustrates a wireless device 400 (e.g., wireless device 12) as implemented in accordance with one or more embodiments. As shown, the wireless device 400 includes processing circuitry 410 and communication circuitry 420. The communication circuitry 420 (e.g., radio circuitry) is configured to transmit and/or receive information to and/or from one or more other nodes, e.g., via any communication technology. Such communication may occur via one or more antennas that are either internal or external to the wireless device 400. The processing circuitry 410 is configured to perform processing described above, e.g., in FIG. 2, such as by executing instructions stored in memory 430. The processing circuitry 410 in this regard may implement certain functional means, units, or modules.

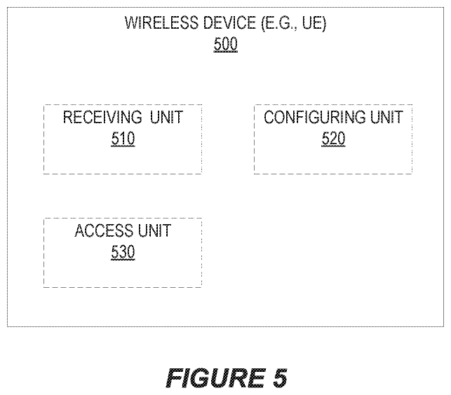

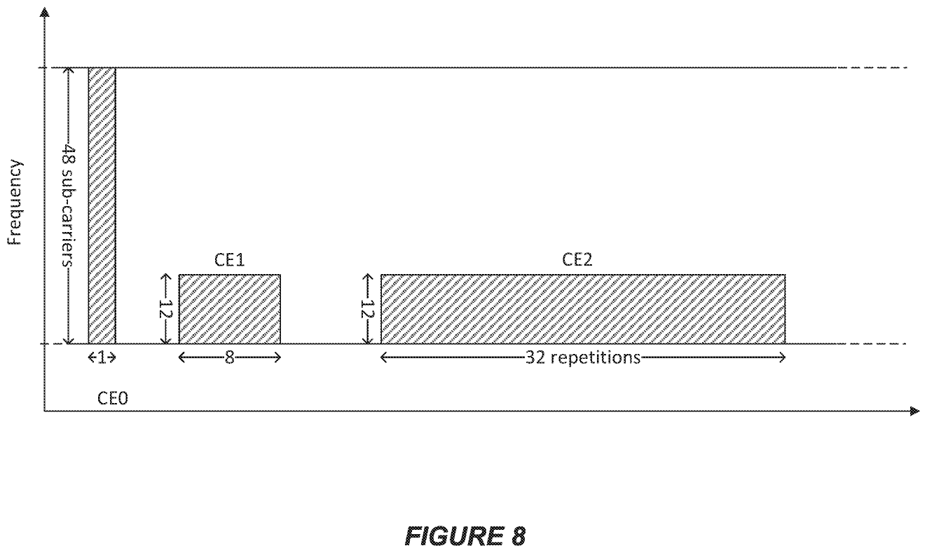

FIG. 5 illustrates a schematic block diagram of a wireless device 500 (e.g., wireless device 14) in a wireless network 10 according to still other embodiments (for example, the wireless network shown in FIG. 8). As shown, the wireless device 500 implements various functional means, units, or modules, e.g., via the processing circuitry 410 in FIG. 4 and/or via software code. These functional means, units, or modules, e.g., for implementing the method in FIG. 2, include for instance a receiving unit 510 for receiving the information 22, a configuring unit 520 for configuring the wireless device to restrict access to the network 10, and/or an access unit 530 for restricting access to the network 10.

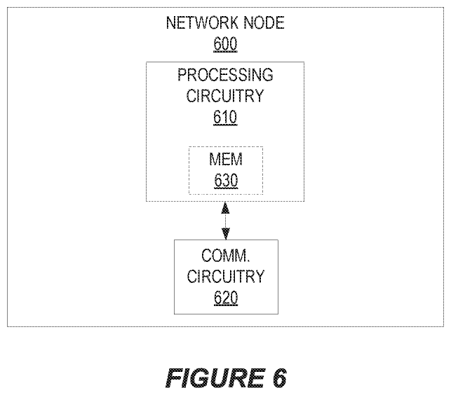

FIG. 6 illustrates a network node 600 (e.g., network node 18) as implemented in accordance with one or more embodiments. As shown, the network node 600 includes processing circuitry 610 and communication circuitry 620. The communication circuitry 620 is configured to transmit and/or receive information to and/or from one or more other nodes, e.g., via any communication technology. The processing circuitry 610 is configured to perform processing described above, such as by executing instructions stored in memory 630. The processing circuitry 610 in this regard may implement certain functional means, units, or modules.

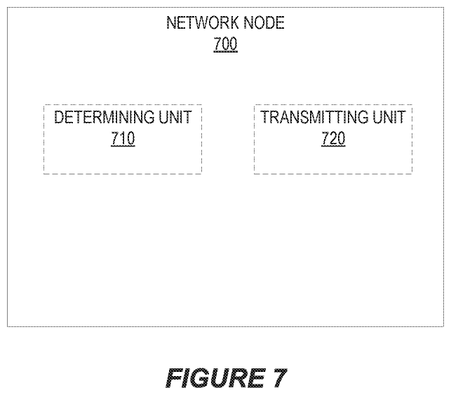

FIG. 7 illustrates a schematic block diagram of a network node 700 (e.g., network node 18) in a wireless network 10 according to still other embodiments (for example, the wireless network shown in FIG. 8). As shown, the network node 700 implements various functional means, units, or modules, e.g., via the processing circuitry 610 in FIG. 6 and/or via software code. These functional means, units, or modules, e.g., for implementing the method in FIG. 3, include for instance a transmitting unit 720 for transmitting the information 22 and/or a determining unit 710 for determining to restrict access by the wireless device 14 to the network 10.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

For LTE-MTC (here also referred to LTE-M or eMTC for any release), although some features for MTC were introduced already in Rel-11 (Enhanced Access Class Barring, EAB), and Rel-12 (Cat-0), the main changes of reduced device bandwidth support and coverage enhancements (CE) were introduced in Rel-13 for UE Cat-M1. CE support of up to 15 dB is achieved by time repetition in a transmission time interval (TTI) bundling manner, similar to that introduced for Voice over Internet Protocol (VoIP) in Rel-8. In Rel-8, TTI bundling is limited to the uplink shared data channel and fixed to 4 repetitions. For Rel-13, MTC user equipments (UEs) requiring coverage enhancements, the number of repetitions can be configured per cell or per UE, and will also be applied to the downlink. Up to 2048 repetitions for the Physical Uplink Shared Channel (PUSCH) and Physical Downlink Shared Channel (PDSCH) support CE even larger than that of the initial 15 dB design target. For random access (RA), 4 different CE-levels was introduced, i.e. 4 different Physical Random Access Channel (PRACH) configurations with different repetition levels. The UE selects a PRACH resource with a CE-level matching is coverage based on Reference Signal Received Power (RSRP) measurement.

In Rel-12, a lower complexity (LC) UE category (Cat-0) was introduced to support lower manufacturing costs for MTC devices. In Rel-13 further complexity reductions were introduced where the largest change is a reduced device bandwidth to 6 physical resource blocks (PRBs) or 1.4 MHz. This means that some legacy channels like the downlink control channel, PDCCH, which spans over the entire system bandwidth, cannot be received. For these low complexity UEs (Cat-M1) the Physical Downlink Control Channel (PDCCH) is replaced with an MTC PDCCH (MPDCCH) signal transmitted only within 6 PRBs. The lower complexity of the devices means that a small number of repetitions might be needed also for these devices in normal coverage, i.e. to compensate for the losses from using only one receiving antenna, loss of frequency diversity, etc. Further, as part of the complexity reduction and CE, cross-subframe scheduling is used; that is, a transmission is first scheduled by repetitions on MPDCCH and then the repetitions of the actual data transmission (PUSCH or PDSCH) are carried out at first after the final MPDCCH repetition.

Two types of CE modes were introduced in Rel-13: CE mode A supporting a small number of repetitions (up to 32 for shared data channels), and CE mode B supporting a large number of repetitions (up to 2048 for shared data channels). In practice, whether the UE is configured with CE mode A or B will mean it used different configurations for e.g. Random Access, MPDCCH monitoring, PDSCH transmissions etc. That is, different search spaces and frequency hopping parameters apply. For Random Access, the four CE levels are divided such CE-level 0 and CE-level 1 use CE mode A configuration, whereas the higher CE-levels 2 and 3 use CE mode B configuration.

In Rel-14, LTE-M was further enhanced with a number of features and the introduction of a more wide bandwidth UE category, Cat-M2, supporting higher data rate with a bandwidth of 5 MHz or 24 PRBs.

As for Access Control, LTE-M UEs are as all LTE UEs subject to the Access Class Barring (ACB) in SystemInformationBlockType2(-BR), and in addition to this the EAB mechanism controlled by SysteminformationBlockType14(-BR) mentioned above. That is, if the UE is barred according to one of these mechanisms it is temporarily not allowed to access the cell and initiate an access attempt.

NB-IoT was introduced in 3GPP in Release 13 and supports enhancements to support Machine-Type Communications (MTC) with a new radio interface (and UE categories Cat-NB1 and Cat-NB2). (The notation NB-IoT is here used for any Release).

For NB-IoT, three different operation modes are defined, i.e., stand-alone, guard-band, and in-band. In stand-alone mode, the NB-IoT system is operated in dedicated frequency bands. For in-band operation, the NB-IoT system can be placed inside the frequency bands used by the current LTE system, while in the guard-band mode, the NB-IoT system can be operated in the guard band used by the current LTE system. NB-IoT can operate with a system bandwidth of 180 kHz (Cat-NB1, Cat-NB2). NB-IoT supports multi-carrier operation, where several 180 kHz PRBs can be used, e.g., for increasing the system capacity, inter-cell interference coordination, load balancing, etc. The NB-IoT device listens to the system information on the anchor carrier, but when there is data, the communication can be moved to a secondary carrier. Rel-13 UEs need to use the anchor carrier for random access whereas Rel-14 UEs may use the non-anchor carriers if configured. Otherwise, such as when attempting to access the network for attach, Rel-14 UEs also need to use the anchor carrier.

Anchor carrier configuration, such as the radio resource configuration, uplink carrier frequency, random access parameters, paging configuration and the static physical layer parameters, are done in SIB2-NB while non-anchor carriers are configured by SIB22-NB. The parameter maxNonAnchorCarriers-NB-r14 defines the maximum number of non-anchor carriers supported in Release 14; the maximum is 15 in addition to the anchor carrier.

According to TS 36.300 v. 14.2.0, the UE in RRC_CONNECTED can be configured, via UE-specific RRC signaling, to a non-anchor carrier, for all unicast transmissions. The UE in RRC_IDLE, based on broadcast signaling, can use a non-anchor carrier for paging reception and/or PRACH access. If the non-anchor carrier is not configured for the UE, all transmissions occur on the anchor carrier.

NB-IoT uses repeated transmissions to extend its coverage compared to earlier supported 3GPP radio access technologies. When accessing the system, an UE may for example repeat the Narrow Band Random Access Channel (NPRACH) preamble transmission up to 128 times to achieve coverage in the most demanding situations. The NB-IoT radio interface has therefore been designed with three separate NPRACH radio resources that each is associated with a coverage range and a set of repetitions. That is, CE-levels 0,1, and 2 are supported, unlike eMTC which supports 4. The selects the CE-level and NPRACH resource in the same manner based on RSRP-measurement.

FIG. 8 illustrates a typical NPRACH configuration. The left most NPRACH resource is intended for UEs in good radio conditions, where the random access preamble is sent a single time. The system may configure two additional NPRACH resources to be used by UEs in extended and extreme coverage. Each NPRACH resource is associated with a Coverage Extension (CE) level. A CE level is furthermore associated with a set of repetitions of the random access preamble transmission. The number of repetitions is increasing with the coverage intended to be supported by the NPRACH resource.

FIG. 8 illustrates a typical NPRACH configuration with three resources for Coverage level 0 (CE0), 1 (CE1) and 2 (CE2).

To select an NPRACH resource, the UE measures the downlink received power (RSRP) and based on this and a set of broadcasted signal level thresholds makes a selection of the NPRACH resource to use for its system access, i.e. the number of times the random access frequency hopping symbol group should be repeated.

In Release 13 there is, unlike LTE-M, only one mechanism for access control; NB-IoT access class barring (AB). NB-IoT AB performs barring based on the UE access classes 0-9 with separate configurations also for access classes 10-15 (emergency call and special access classes) and ExceptionData. AB is configured in SIB14-NB to bar UEs based on access classes 0-9 and within the access classes, all UEs or only UEs which are not in their most preferred PLMN and/or their HPLMN may be barred. AB can be configured separately per PLMN. Before initiating RRC connection establishment or resume, UEs must acquire MIB-NB, which contains an ab-Enabled-r13-flag, which informs whether AB is enabled in the cell. If AB is enabled, the UE must acquire SIB14-NB to see whether its own access class is barred.

LoRa, Sigfox, and Ingenu are three wide-area IoT solutions that have been deployed in certain markets. These solutions are very uplink oriented as they can work even without a downlink. They can also work without the frame structure, i.e. no notion of subframe, frame, hyperframe, etc. In these systems, a UE who has data to send can simply send the data without any uplink grant. Such uplink grant-free access is vulnerable to potential collision at high traffic loads. Furthermore, in these systems, the uplink data is transmitted in Msg1.

There currently exist certain challenge(s). MTC is designed to provide very long battery life for devices. 10 years is often used as a design target to avoid frequent battery charging or replacement. This however also leads to an unforeseen problem: devices will remain in the networks long after they have served their purpose and have become obsolete. Some of the devices are deployed in a nomadic matter, e.g., sensors in forests or lakes. These devices may not be intended to be retrieved after deployment, and therefore, they cannot be easily disabled when they are obsolete. This will cause performance degradation in the networks since these obsolete devices may continue to access the network (the connection request can only be rejected in the later stage by the network). The current load control mechanisms can only temporarily combat the problem but not prevent the devices from trying to access the network again at a later point in time, e.g., access barring mechanism is meant to be used temporarily upon congestion and it applies to all access classes, i.e. 0 to 9, regardless of a device, which belongs to a particular class, being obsolete, RRC reject and (extended) wait time only prolongs the time before the device will attempt to access again.

Certain aspects of the present disclosure and their embodiments may provide solutions to these or other challenges. Some embodiments herein provide long-term semi-static barring or access control of obsolete UEs with long battery life. The embodiments may shut down devices from a radio point-of-view, e.g., for both uplink transmission and downlink transmission. Other embodiments however only concern access control for uplink transmission. This uplink-only approach means obsolete UEs will still be reachable in the downlink by paging, e.g. for later re-configuration, application layer changes or firmware update/replacement, but not allowed to access in uplink and therefore not causing any performance degradation or affecting the UL capacity of the network.

The UE access can be stopped at different levels and configured e.g. to be permanently barred at a RAN-level, such that non-access stratum (NAS) procedures are not permitted, at an application level, etc. Some embodiments include a method to keep obsolete MTC devices, which remain in the network long after they are in service, from accessing the network and accessing the RAN.

More particularly, there have been several features introduced for MTC in order to extend UE battery life since frequent charging or replacement is not feasible for massive numbers of devices in the field. Note that several of these features, such as power-saving mode (PSM) and extended discontinuous reception (eDRX), are also available to LTE in general and some embodiments presented here are equally applicable to them.

Due to this long UE battery life, obsolete devices may remain in the network years after they are no longer used. One solution would be to update the UE's firmware or make changes in the application layer once the UE is no longer needed such that the application will not initiate any access attempts. This however requires an active change and once a service is no longer needed it typically does not obtain much attention. It is therefore likely that UEs will just be left in the network after they have become obsolete and degrade network performance unnecessarily. Hence some embodiments herein provide operators with some tool to control these obsolete and unattended UEs. Operators may even require to have such tool/feature in place and that devices are capable of it before allowing the MTC devices to be deployed in the network (capability signaling would be as for other features).

Various embodiments are discussed herein for restricting access for a UE. In a first embodiment, UEs can be deactivated altogether (e.g., on a radio level), meaning the UEs will neither transmit nor receive. However, this means that effectively the device is shut down and can never be reached or re-configured again. Therefore, a second embodiment herein is that UEs are only restricted from transmitting in the uplink. That is, a UE could later be reached in downlink and re-configured or its application/firmware updated to serve a new purpose. Note that as part of this embodiment, UEs may be allowed to access in the uplink when paged in the downlink. In this case there would be no negative impact on network performance from obsolete UEs still receiving in the downlink and monitoring paging. There would of course be negative impact in terms of memory consumption etc. from having the UEs attached to the network but this can be fully controlled by the network.

The above embodiments for restricting the UE access can be implemented on different levels in the network which would result in different embodiments:

On a RAN-based level, a new permanently barred access class is introduced in some embodiments such that the UE would not be allowed to initiate connection establishment, e.g., RRC connection establishment. Note that no indication in system information is required for this new permanently barred access class since it is always barred. Unlike the existing access classes, a UE may be configured to belong to this new access class via dedicated signaling. The configuration may be done by any of the methods described below.

In some embodiments, the network can configure the barred access class to access the network by, e.g., explicit indications in the system information or paging message under some circumstances (e.g., emergency situations in which the obsolete devices can be made useful), or implicitly specified, e.g., if the UE is being paged, it can perform random access regardless it is permanently barred.

In another embodiment, UEs that belong to a particular group, e.g. a utility operator, are assigned a group ID, so that when scrambled with an identifier which is broadcast in system information access to network is activated/deactivated for X time units. The value X can either be a fixed value or signaled explicitly.

On an MME/NAS-based level, when configured (most naturally by negotiation over NAS), the UE would not be allowed to trigger any procedure (e.g., NAS procedure) which would lead to initiation connection establishment (or resumption), e.g., RRC connection establishment. That is, the UE would be stopped when otherwise any of the following procedures would be triggered: Attach, tracking area update (TAU), Detach, (paging), Service request, Extended service request.

On a subscription-based level, according to this embodiment, it would be indicated in the UEs subscription information whether access is allowed or stopped. That is, already at the subscription level this is indicated. This is a good option since restricting the UE operation for a long time period, or even permanently, may need a high level of security in order for the UE to trust it.

One safe option would e.g. be to reconfigure a protected file on the USIM application over-the-air (for example the new proposed access class), indicating to the UE that it has been deactivated and shall not perform NAS registration. Or perhaps alternatively the UE could possibly be prevented from performing NAS registration by using similar over-the-air configuration to delete some key file like IMSI. Only the home operator i administrator would be able to perform these operations. Note that some of the above would also remove the downlink reachability of the UE, and might be more suitable when there is no need to be able to remotely reactivate it, for example when the subscription/IMSI is removed also in the network.

In one embodiment of this, the USIM could be reconfigured to set a new file indicating to the UE that it has been “deactivated”, but the UE is still expected to check for IMSI paging every once in a while in case the operator wants to re-enable it.

The configuration for any of the above cases could be done by e.g.: (i) Sticky RRC or MAC configuration (i.e. still valid after the UE is released to RRC_IDLE); (ii) NAS signaling (i.e. negotiated between UE and MME and stored in the UE context); (iii) By alteration of the UE capability or the assignment of a new ‘obsolete UE category’ (most likely done by RRC and if so joint with bullet 1); (iv) By alteration of the subscription information (see USIM and protected file above); or (v) By PLMN such that a new PLMN is introduced for ‘obsolete UEs’ (this bullets more covers what is re-configured and it could be carried out by any of the preceding step, e.g. RRC or NAS signaling).

In yet another embodiment, whenever a UE is configured as an ‘obsolete UE’ it would apply a certain behavior according to which it would ensure downlink reachability but very infrequently, e.g. PSM with a very long periodic TAU timer (note that this would require some uplink signaling but very rarely, e.g. once every 2 weeks). Alternatively, access, and/or paging, would be permitted only in predefined periods or under exceptional situations e.g., emergency cases indicated by the network.

In yet another embodiment, a new RRC establishment cause is introduced for ‘obsolete UE’ and it would be up to the eNB to accept or reject the access attempt (note that there would still be some performance degradation in this case since Msg1 and Msg2 must still be transmitted).

In yet another embodiment, the network indicates in advance through AS- or NAS-signaling whether the UE is authorized to access the network. The indication can be explicit or implicit. Explicit indication can for example be in the form of a 1-bit field signaled to the UE, possibly piggy-backed to other signaling to the UE, where for example the value ‘1’ could mean that the UE is authorized to access the network for another X time units (e.g. months) and value ‘0’ could mean that the UE is not authorized to access the network until the UE receives an indication saying otherwise. The value X could either be fixed or signaled as part of the explicit indication. In case of implicit indication, any signaling from the network to the UE could be interpreted as an authorization allowing the UE to access the network during another X time units.

In yet another embodiment, a new mode of operation for UEs in Idle state is introduced. In this embodiment, this new idle state mode of operation is referred to as Restricted Access Mode (RAM). in similarity with PSM a UE in RAM should suspend parts of its idle mode tasks, In addition to what applies for PSM RAM should allow for further levels of restrictions, e.g.: Suspension of mobile originated connections; Suspension of NAS signaling and/or data such as Routing Area Updates (RAU) and TAU; and Suspension of AS signaling and/or data.

In a further embodiment RAM is activated per UE on cell level, on TA/RA level, or on PLMN level via NAS signaling using one or more bits. The RAM could for the DL reachability part in one embodiment be similar to PSM or eDRX but allow for considerably longer sleep cycles, i.e. on the order of weeks and months.

The decision to configure a UE as ‘obsolete’ according to the above could be based on preconfigured rules or manual intervention. For example, if the UE has not successfully managed to set up a connection, attach/register to the network for a certain period of time T or a number of attempts N, e.g. due to subscription problems or UE malfunction, this could trigger the configuration for the particular UE. Alternatively any measure of re-occurring misconduct from the UE could be a trigger in the same way. Thirdly, any signaling from the application layer, or lack of such for an extended period, could also trigger the configuration of the UE as obsolete.

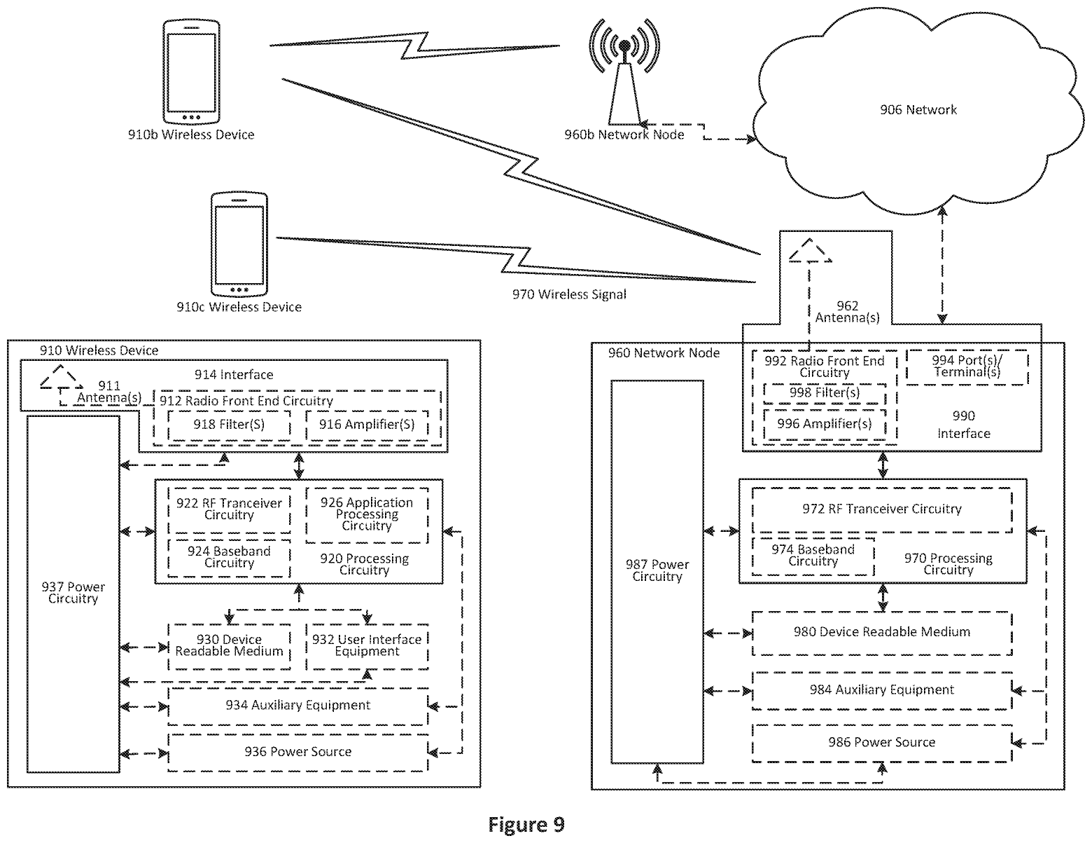

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 906, network nodes 960 and 960b, and WDs 910, 910b, and 910c. In practice, a wireless network may further include any additional elements suitable to support communication between wireless devices or between a wireless device and another communication device, such as a landline telephone, a service provider, or any other network node or end device. Of the illustrated components, network node 960 and wireless device (WD) 910 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 906 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 960 and WD 910 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 960 includes processing circuitry 970, device readable medium 980, interface 990, auxiliary equipment 984, power source 986, power circuitry 987, and antenna 962. Although network node 960 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 960 are depicted as single boxes located within a larger box, or nested within multiple boxes, in practice, a network node may comprise multiple different physical components that make up a single illustrated component (e.g., device readable medium 980 may comprise multiple separate hard drives as well as multiple RAM modules).

Similarly, network node 960 may be composed of multiple physically separate components (e.g., a NodeB component and a RNC component, or a BTS component and a BSC component, etc.), which may each have their own respective components. In certain scenarios in which network node 960 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 960 may be configured to support multiple radio access technologies (RATs). In such embodiments, some components may be duplicated (e.g., separate device readable medium 980 for the different RATs) and some components may be reused (e.g., the same antenna 962 may be shared by the RATs). Network node 960 may also include multiple sets of the various illustrated components for different wireless technologies integrated into network node 960, such as, for example, GSM, WCDMA, LTE, NR, WiFi, or Bluetooth wireless technologies. These wireless technologies may be integrated into the same or different chip or set of chips and other components within network node 960.

Processing circuitry 970 is configured to perform any determining, calculating, or similar operations (e.g., certain obtaining operations) described herein as being provided by a network node. These operations performed by processing circuitry 970 may include processing information obtained by processing circuitry 970 by, for example, converting the obtained information into other information, comparing the obtained information or converted information to information stored in the network node, and/or performing one or more operations based on the obtained information or converted information, and as a result of said processing making a determination.

Processing circuitry 970 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 960 components, such as device readable medium 980, network node 960 functionality. For example, processing circuitry 970 may execute instructions stored in device readable medium 980 or in memory within processing circuitry 970. Such functionality may include providing any of the various wireless features, functions, or benefits discussed herein. In some embodiments, processing circuitry 970 may include a system on a chip (SOC).

In some embodiments, processing circuitry 970 may include one or more of radio frequency (RF) transceiver circuitry 972 and baseband processing circuitry 974. In some embodiments, radio frequency (RF) transceiver circuitry 972 and baseband processing circuitry 974 may be on separate chips (or sets of chips), boards, or units, such as radio units and digital units. In alternative embodiments, part or all of RF transceiver circuitry 972 and baseband processing circuitry 974 may be on the same chip or set of chips, boards, or units

In certain embodiments, some or all of the functionality described herein as being provided by a network node, base station, eNB or other such network device may be performed by processing circuitry 970 executing instructions stored on device readable medium 980 or memory within processing circuitry 970. In alternative embodiments, some or all of the functionality may be provided by processing circuitry 970 without executing instructions stored on a separate or discrete device readable medium, such as in a hard-wired manner. In any of those embodiments, whether executing instructions stored on a device readable storage medium or not, processing circuitry 970 can be configured to perform the described functionality. The benefits provided by such functionality are not limited to processing circuitry 970 alone or to other components of network node 960, but are enjoyed by network node 960 as a whole, and/or by end users and the wireless network generally.

Device readable medium 980 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 970. Device readable medium 980 may store any suitable instructions, data or information, including a computer program, software, an application including one or more of logic, rules, code, tables, etc. and/or other instructions capable of being executed by processing circuitry 970 and, utilized by network node 960. Device readable medium 980 may be used to store any calculations made by processing circuitry 970 and/or any data received via interface 990. In some embodiments, processing circuitry 970 and device readable medium 980 may be considered to be integrated.

Interface 990 is used in the wired or wireless communication of signalling and/or data between network node 960, network 906, and/or WDs 910. As illustrated, interface 990 comprises port(s)/terminal(s) 994 to send and receive data, for example to and from network 906 over a wired connection. Interface 990 also includes radio front end circuitry 992 that may be coupled to, or in certain embodiments a part of, antenna 962. Radio front end circuitry 992 comprises filters 998 and amplifiers 996. Radio front end circuitry 992 may be connected to antenna 962 and processing circuitry 970. Radio front end circuitry may be configured to condition signals communicated between antenna 962 and processing circuitry 970. Radio front end circuitry 992 may receive digital data that is to be sent out to other network nodes or WDs via a wireless connection. Radio front end circuitry 992 may convert the digital data into a radio signal having the appropriate channel and bandwidth parameters using a combination of filters 998 and/or amplifiers 996. The radio signal may then be transmitted via antenna 962. Similarly, when receiving data, antenna 962 may collect radio signals which are then converted into digital data by radio front end circuitry 992. The digital data may be passed to processing circuitry 970. In other embodiments, the interface may comprise different components and/or different combinations of components.

In certain alternative embodiments, network node 960 may not include separate radio front end circuitry 992, instead, processing circuitry 970 may comprise radio front end circuitry and may be connected to antenna 962 without separate radio front end circuitry 992. Similarly, in some embodiments, all or some of RF transceiver circuitry 972 may be considered a part of interface 990. In still other embodiments, interface 990 may include one or more ports or terminals 994, radio front end circuitry 992, and RF transceiver circuitry 972, as part of a radio unit (not shown), and interface 990 may communicate with baseband processing circuitry 974, which is part of a digital unit (not shown).

Antenna 962 may include one or more antennas, or antenna arrays, configured to send and/or receive wireless signals. Antenna 962 may be coupled to radio front end circuitry 990 and may be any type of antenna capable of transmitting and receiving data and/or signals wirelessly. In some embodiments, antenna 962 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 962 may be separate from network node 960 and may be connectable to network node 960 through an interface or port.

Antenna 962, interface 990, and/or processing circuitry 970 may be configured to perform any receiving operations and/or certain obtaining operations described herein as being performed by a network node. Any information, data and/or signals may be received from a wireless device, another network node and/or any other network equipment. Similarly, antenna 962, interface 990, and/or processing circuitry 970 may be configured to perform any transmitting operations described herein as being performed by a network node. Any information, data and/or signals may be transmitted to a wireless device, another network node and/or any other network equipment.

Power circuitry 987 may comprise, or be coupled to, power management circuitry and is configured to supply the components of network node 960 with power for performing the functionality described herein. Power circuitry 987 may receive power from power source 986. Power source 986 and/or power circuitry 987 may be configured to provide power to the various components of network node 960 in a form suitable for the respective components (e.g., at a voltage and current level needed for each respective component). Power source 986 may either be included in, or external to, power circuitry 987 and/or network node 960. For example, network node 960 may be connectable to an external power source (e.g., an electricity outlet) via an input circuitry or interface such as an electrical cable, whereby the external power source supplies power to power circuitry 987. As a further example, power source 986 may comprise a source of power in the form of a battery or battery pack which is connected to, or integrated in, power circuitry 987. The battery may provide backup power should the external power source fail. Other types of power sources, such as photovoltaic devices, may also be used.

Alternative embodiments of network node 960 may include additional components beyond those shown in FIG. 9 that may be responsible for providing certain aspects of the network node's functionality, including any of the functionality described herein and/or any functionality necessary to support the subject matter described herein. For example, network node 960 may include user interface equipment to allow input of information into network node 960 and to allow output of information from network node 960. This may allow a user to perform diagnostic, maintenance, repair, and other administrative functions for network node 960.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band Internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 910 includes antenna 911, interface 914, processing circuitry 920, device readable medium 930, user interface equipment 932, auxiliary equipment 934, power source 936 and power circuitry 937. WD 910 may include multiple sets of one or more of the illustrated components for different wireless technologies supported by WD 910, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 910.

Antenna 911 may include one or more antennas or antenna arrays, configured to send and/or receive wireless signals, and is connected to interface 914. In certain alternative embodiments, antenna 911 may be separate from WD 910 and be connectable to WD 910 through an interface or port. Antenna 911, interface 914, and/or processing circuitry 920 may be configured to perform any receiving or transmitting operations described herein as being performed by a WD. Any information, data and/or signals may be received from a network node and/or another WD. In some embodiments, radio front end circuitry and/or antenna 911 may be considered an interface.

As illustrated, interface 914 comprises radio front end circuitry 912 and antenna 911. Radio front end circuitry 912 comprise one or more filters 918 and amplifiers 916. Radio front end circuitry 914 is connected to antenna 911 and processing circuitry 920, and is configured to condition signals communicated between antenna 911 and processing circuitry 920. Radio front end circuitry 912 may be coupled to or a part of antenna 911. In some embodiments, WD 910 may not include separate radio front end circuitry 912; rather, processing circuitry 920 may comprise radio front end circuitry and may be connected to antenna 911. Similarly, in some embodiments, some or all of RF transceiver circuitry 922 may be considered a part of interface 914. Radio front end circuitry 912 may receive digital data that is to be sent out to other network nodes or WDs via a wireless connection. Radio front end circuitry 912 may convert the digital data into a radio signal having the appropriate channel and bandwidth parameters using a combination of filters 918 and/or amplifiers 916. The radio signal may then be transmitted via antenna 911. Similarly, when receiving data, antenna 911 may collect radio signals which are then converted into digital data by radio front end circuitry 912. The digital data may be passed to processing circuitry 920. In other embodiments, the interface may comprise different components and/or different combinations of components.

Processing circuitry 920 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 910 components, such as device readable medium 930, WD 910 functionality. Such functionality may include providing any of the various wireless features or benefits discussed herein. For example, processing circuitry 920 may execute instructions stored in device readable medium 930 or in memory within processing circuitry 920 to provide the functionality disclosed herein.

As illustrated, processing circuitry 920 includes one or more of RF transceiver circuitry 922, baseband processing circuitry 924, and application processing circuitry 926. In other embodiments, the processing circuitry may comprise different components and/or different combinations of components. In certain embodiments processing circuitry 920 of WD 910 may comprise a SOC. In some embodiments, RF transceiver circuitry 922, baseband processing circuitry 924, and application processing circuitry 926 may be on separate chips or sets of chips. In alternative embodiments, part or all of baseband processing circuitry 924 and application processing circuitry 926 may be combined into one chip or set of chips, and RF transceiver circuitry 922 may be on a separate chip or set of chips. In still alternative embodiments, part or all of RF transceiver circuitry 922 and baseband processing circuitry 924 may be on the same chip or set of chips, and application processing circuitry 926 may be on a separate chip or set of chips. In yet other alternative embodiments, part or all of RF transceiver circuitry 922, baseband processing circuitry 924, and application processing circuitry 926 may be combined in the same chip or set of chips. In some embodiments, RF transceiver circuitry 922 may be a part of interface 914. RF transceiver circuitry 922 may condition RF signals for processing circuitry 920.

In certain embodiments, some or all of the functionality described herein as being performed by a WD may be provided by processing circuitry 920 executing instructions stored on device readable medium 930, which in certain embodiments may be a computer-readable storage medium. In alternative embodiments, some or all of the functionality may be provided by processing circuitry 920 without executing instructions stored on a separate or discrete device readable storage medium, such as in a hard-wired manner. In any of those particular embodiments, whether executing instructions stored on a device readable storage medium or not, processing circuitry 920 can be configured to perform the described functionality. The benefits provided by such functionality are not limited to processing circuitry 920 alone or to other components of WD 910, but are enjoyed by WD 910 as a whole, and/or by end users and the wireless network generally.

Processing circuitry 920 may be configured to perform any determining, calculating, or similar operations (e.g., certain obtaining operations) described herein as being performed by a WD. These operations, as performed by processing circuitry 920, may include processing information obtained by processing circuitry 920 by, for example, converting the obtained information into other information, comparing the obtained information or converted information to information stored by WD 910, and/or performing one or more operations based on the obtained information or converted information, and as a result of said processing making a determination.

Device readable medium 930 may be operable to store a computer program, software, an application including one or more of logic, rules, code, tables, etc. and/or other instructions capable of being executed by processing circuitry 920. Device readable medium 930 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 920. In some embodiments, processing circuitry 920 and device readable medium 930 may be considered to be integrated.

User interface equipment 932 may provide components that allow for a human user to interact with WD 910. Such interaction may be of many forms, such as visual, audial, tactile, etc. User interface equipment 932 may be operable to produce output to the user and to allow the user to provide input to WD 910. The type of interaction may vary depending on the type of user interface equipment 932 installed in WD 910. For example, if WD 910 is a smart phone, the interaction may be via a touch screen; if WD 910 is a smart meter, the interaction may be through a screen that provides usage (e.g., the number of gallons used) or a speaker that provides an audible alert (e.g., if smoke is detected). User interface equipment 932 may include input interfaces, devices and circuits, and output interfaces, devices and circuits. User interface equipment 932 is configured to allow input of information into WD 910, and is connected to processing circuitry 920 to allow processing circuitry 920 to process the input information. User interface equipment 932 may include, for example, a microphone, a proximity or other sensor, keys/buttons, a touch display, one or more cameras, a USB port, or other input circuitry. User interface equipment 932 is also configured to allow output of information from WD 910, and to allow processing circuitry 920 to output information from WD 910. User interface equipment 932 may include, for example, a speaker, a display, vibrating circuitry, a USB port, a headphone interface, or other output circuitry. Using one or more input and output interfaces, devices, and circuits, of user interface equipment 932, WD 910 may communicate with end users and/or the wireless network, and allow them to benefit from the functionality described herein.

Auxiliary equipment 934 is operable to provide more specific functionality which may not be generally performed by WDs. This may comprise specialized sensors for doing measurements for various purposes, interfaces for additional types of communication such as wired communications etc. The inclusion and type of components of auxiliary equipment 934 may vary depending on the embodiment and/or scenario.

Power source 936 may, in some embodiments, be in the form of a battery or battery pack. Other types of power sources, such as an external power source (e.g., an electricity outlet), photovoltaic devices or power cells, may also be used. WD 910 may further comprise power circuitry 937 for delivering power from power source 936 to the various parts of WD 910 which need power from power source 936 to carry out any functionality described or indicated herein. Power circuitry 937 may in certain embodiments comprise power management circuitry. Power circuitry 937 may additionally or alternatively be operable to receive power from an external power source; in which case WD 910 may be connectable to the external power source (such as an electricity outlet) via input circuitry or an interface such as an electrical power cable. Power circuitry 937 may also in certain embodiments be operable to deliver power from an external power source to power source 936. This may be, for example, for the charging of power source 936. Power circuitry 937 may perform any formatting, converting, or other modification to the power from power source 936 to make the power suitable for the respective components of WD 910 to which power is supplied.

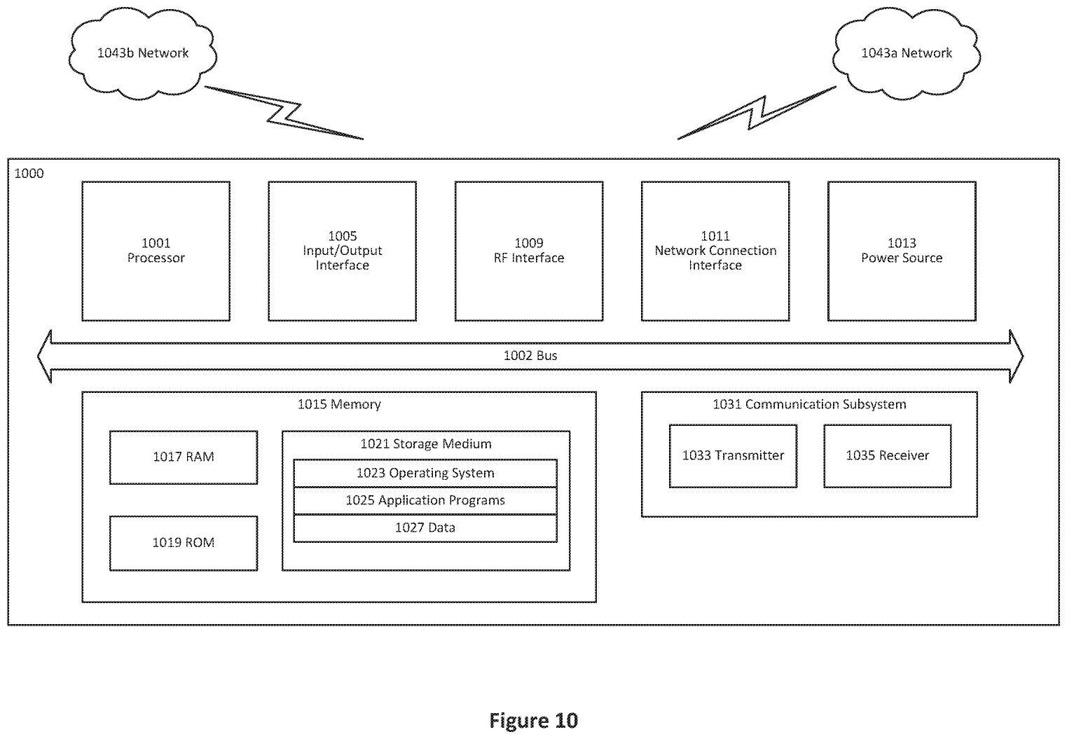

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 10200 may be any UE identified by the 3^{rd} Generation Partnership Project (3GPP), including a NB-IoT UE, a machine type communication (MTC) UE, and/or an enhanced MTC (eMTC) UE. UE 1000, as illustrated in FIG. 10, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 1000 includes processing circuitry 1001 that is operatively coupled to input/output interface 1005, radio frequency (RF) interface 1009, network connection interface 1011, memory 1015 including random access memory (RAM) 1017, read-only memory (ROM) 1019, and storage medium 1021 or the like, communication subsystem 1031, power source 1033, and/or any other component, or any combination thereof. Storage medium 1021 includes operating system 1023, application program 1025, and data 1027. In other embodiments, storage medium 1021 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 1001 may be configured to process computer instructions and data. Processing circuitry 1001 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1001 may include two central processing units (CPUs). Data may be information in a form suitable for use by a computer.

In the depicted embodiment, input/output interface 1005 may be configured to provide a communication interface to an input device, output device, or input and output device. UE 1000 may be configured to use an output device via input/output interface 1005. An output device may use the same type of interface port as an input device. For example, a USB port may be used to provide input to and output from UE 1000. The output device may be a speaker, a sound card, a video card, a display, a monitor, a printer, an actuator, an emitter, a smartcard, another output device, or any combination thereof. UE 1000 may be configured to use an input device via input/output interface 1005 to allow a user to capture information into UE 1000. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 1009 may be configured to provide a communication interface to RF components such as a transmitter, a receiver, and an antenna. Network connection interface 1011 may be configured to provide a communication interface to network 1043a. Network 1043a may encompass wired and/or wireless networks such as a local-area network (LAN), a wide-area network (WAN), a computer network, a wireless network, a telecommunications network, another like network or any combination thereof. For example, network 1043a may comprise a Wi-Fi network. Network connection interface 1011 may be configured to include a receiver and a transmitter interface used to communicate with one or more other devices over a communication network according to one or more communication protocols, such as Ethernet, TCP/IP, SONET, ATM, or the like. Network connection interface 1011 may implement receiver and transmitter functionality appropriate to the communication network links (e.g., optical, electrical, and the like). The transmitter and receiver functions may share circuit components, software or firmware, or alternatively may be implemented separately.

RAM 1017 may be configured to interface via bus 1002 to processing circuitry 1001 to provide storage or caching of data or computer instructions during the execution of software programs such as the operating system, application programs, and device drivers. ROM 1019 may be configured to provide computer instructions or data to processing circuitry 1001. For example, ROM 1019 may be configured to store invariant low-level system code or data for basic system functions such as basic input and output (I/O), startup, or reception of keystrokes from a keyboard that are stored in a non-volatile memory. Storage medium 1021 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1021 may be configured to include operating system 1023, application program 1025 such as a web browser application, a widget or gadget engine or another application, and data file 1027. Storage medium 1021 may store, for use by UE 1000, any of a variety of various operating systems or combinations of operating systems.

Storage medium 1021 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1021 may allow UE 1000 to access computer-executable instructions, application programs or the like, stored on transitory or non-transitory memory media, to off-load data, or to upload data. An article of manufacture, such as one utilizing a communication system may be tangibly embodied in storage medium 1021, which may comprise a device readable medium.

In FIG. 10, processing circuitry 1001 may be configured to communicate with network 1043b using communication subsystem 1031. Network 1043a and network 1043b may be the same network or networks or different network or networks. Communication subsystem 1031 may be configured to include one or more transceivers used to communicate with network 1043b. For example, communication subsystem 1031 may be configured to include one or more transceivers used to communicate with one or more remote transceivers of another device capable of wireless communication such as another WD, UE, or base station of a radio access network (RAN) according to one or more communication protocols, such as IEEE 802.10, CDMA, WCDMA, GSM, LTE, UTRAN, WiMax, or the like. Each transceiver may include transmitter 1033 and/or receiver 1035 to implement transmitter or receiver functionality, respectively, appropriate to the RAN links (e.g., frequency allocations and the like). Further, transmitter 1033 and receiver 1035 of each transceiver may share circuit components, software or firmware, or alternatively may be implemented separately.

In the illustrated embodiment, the communication functions of communication subsystem 1031 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1031 may include cellular communication, Wi-Fi communication, Bluetooth communication, and GPS communication. Network 1043b may encompass wired and/or wireless networks such as a local-area network (LAN), a wide-area network (WAN), a computer network, a wireless network, a telecommunications network, another like network or any combination thereof. For example, network 1043b may be a cellular network, a Wi-Fi network, and/or a near-field network. Power source 1013 may be configured to provide alternating current (AC) or direct current (DC) power to components of UE 1000.

The features, benefits and/or functions described herein may be implemented in one of the components of UE 1000 or partitioned across multiple components of UE 1000. Further, the features, benefits, and/or functions described herein may be implemented in any combination of hardware, software or firmware. In one example, communication subsystem 1031 may be configured to include any of the components described herein. Further, processing circuitry 1001 may be configured to communicate with any of such components over bus 1002. In another example, any of such components may be represented by program instructions stored in memory that when executed by processing circuitry 1001 perform the corresponding functions described herein. In another example, the functionality of any of such components may be partitioned between processing circuitry 1001 and communication subsystem 1031. In another example, the non-computationally intensive functions of any of such components may be implemented in software or firmware and the computationally intensive functions may be implemented in hardware.

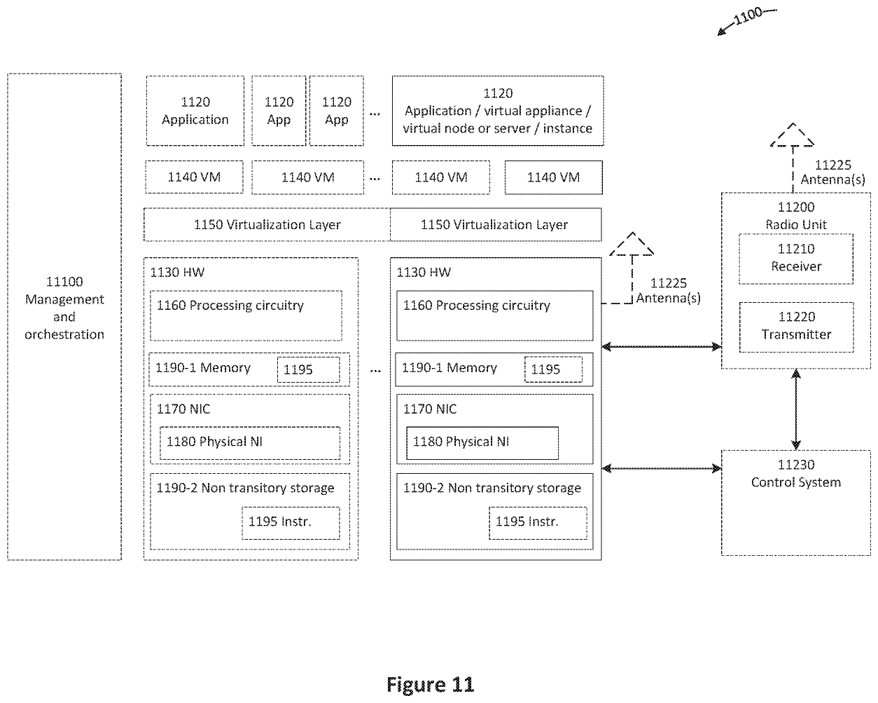

FIG. 11 is a schematic block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1100 hosted by one or more of hardware nodes 1130. Further, in embodiments in which the virtual node is not a radio access node or does not require radio connectivity (e.g., a core network node), then the network node may be entirely virtualized.

The functions may be implemented by one or more applications 1120 (which may alternatively be called software instances, virtual appliances, network functions, virtual nodes, virtual network functions, etc.) operative to implement some of the features, functions, and/or benefits of some of the embodiments disclosed herein. Applications 1120 are run in virtualization environment 1100 which provides hardware 1130 comprising processing circuitry 1160 and memory 1190. Memory 1190 contains instructions 1195 executable by processing circuitry 1160 whereby application 1120 is operative to provide one or more of the features, benefits, and/or functions disclosed herein.

Virtualization environment 1100, comprises general-purpose or special-purpose network hardware devices 1130 comprising a set of one or more processors or processing circuitry 1160, which may be commercial off-the-shelf (COTS) processors, dedicated Application Specific Integrated Circuits (ASICs), or any other type of processing circuitry including digital or analog hardware components or special purpose processors. Each hardware device may comprise memory 1190-1 which may be non-persistent memory for temporarily storing instructions 1195 or software executed by processing circuitry 1160. Each hardware device may comprise one or more network interface controllers (NICs) 1170, also known as network interface cards, which include physical network interface 1180. Each hardware device may also include non-transitory, persistent, machine-readable storage media 1190-2 having stored therein software 1195 and/or instructions executable by processing circuitry 1160. Software 1195 may include any type of software including software for instantiating one or more virtualization layers 1150 (also referred to as hypervisors), software to execute virtual machines 1140 as well as software allowing it to execute functions, features and/or benefits described in relation with some embodiments described herein.

Virtual machines 1140, comprise virtual processing, virtual memory, virtual networking or interface and virtual storage, and may be run by a corresponding virtualization layer 1150 or hypervisor. Different embodiments of the instance of virtual appliance 1120 may be implemented on one or more of virtual machines 1140, and the implementations may be made in different ways.

During operation, processing circuitry 1160 executes software 1195 to instantiate the hypervisor or virtualization layer 1150, which may sometimes be referred to as a virtual machine monitor (VMM). Virtualization layer 1150 may present a virtual operating platform that appears like networking hardware to virtual machine 1140.

As shown in FIG. 11, hardware 1130 may be a standalone network node with generic or specific components. Hardware 1130 may comprise antenna 11225 and may implement some functions via virtualization. Alternatively, hardware 1130 may be part of a larger cluster of hardware (e.g. such as in a data center or customer premise equipment (CPE)) where many hardware nodes work together and are managed via management and orchestration (MANO) 11100, which, among others, oversees lifecycle management of applications 1120.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1140 may be a software implementation of a physical machine that runs programs as if they were executing on a physical, non-virtualized machine. Each of virtual machines 1140, and that part of hardware 1130 that executes that virtual machine, be it hardware dedicated to that virtual machine and/or hardware shared by that virtual machine with others of the virtual machines 1140, forms a separate virtual network elements (VNE).

Still in the context of NFV, Virtual Network Function (VNF) is responsible for handling specific network functions that run in one or more virtual machines 1140 on top of hardware networking infrastructure 1130 and corresponds to application 1120 in FIG. 11.

In some embodiments, one or more radio units 11200 that each include one or more transmitters 11220 and one or more receivers 11210 may be coupled to one or more antennas 11225. Radio units 11200 may communicate directly with hardware nodes 1130 via one or more appropriate network interfaces and may be used in combination with the virtual components to provide a virtual node with radio capabilities, such as a radio access node or a base station.

In some embodiments, some signalling can be effected with the use of control system 11230 which may alternatively be used for communication between the hardware nodes 1130 and radio units 11200.

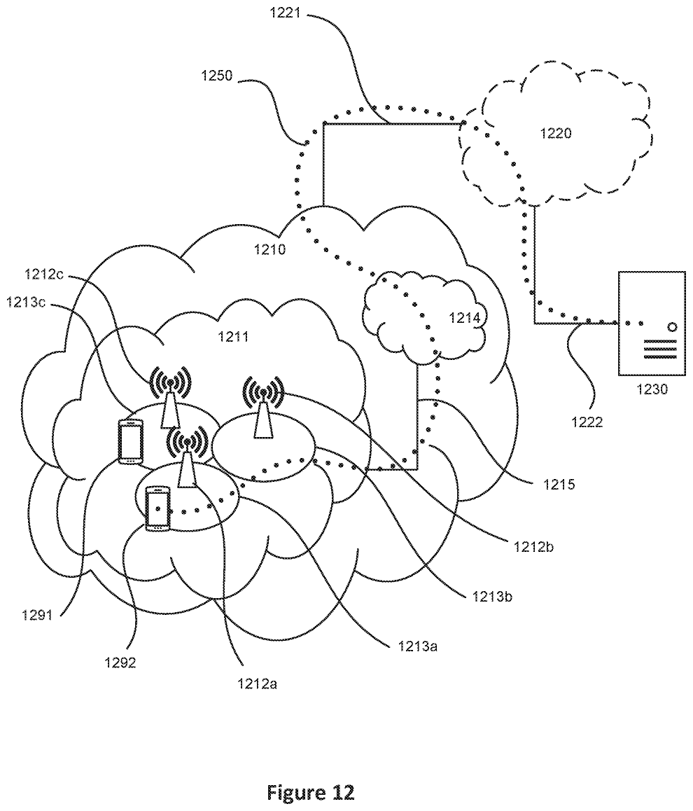

FIG. 12 illustrates a telecommunication network connected via an intermediate network to a host computer in accordance with some embodiments. In particular, with reference to FIG. 12, in accordance with an embodiment, a communication system includes telecommunication network 1210, such as a 3GPP-type cellular network, which comprises access network 1211, such as a radio access network, and core network 1214. Access network 1211 comprises a plurality of base stations 1212a, 1212b, 1212c, such as NBs, eNBs, gNBs or other types of wireless access points, each defining a corresponding coverage area 1213a, 1213b, 1213c. Each base station 1212a, 1212b, 1212c is connectable to core network 1214 over a wired or wireless connection 1215. A first UE 1291 located in coverage area 1213c is configured to wirelessly connect to, or be paged by, the corresponding base station 1212c. A second UE 1292 in coverage area 1213a is wirelessly connectable to the corresponding base station 1212a. While a plurality of UEs 1291, 1292 are illustrated in this example, the disclosed embodiments are equally applicable to a situation where a sole UE is in the coverage area or where a sole UE is connecting to the corresponding base station 1212.

Telecommunication network 1210 is itself connected to host computer 1230, which may be embodied in the hardware and/or software of a standalone server, a cloud-implemented server, a distributed server or as processing resources in a server farm. Host computer 1230 may be under the ownership or control of a service provider, or may be operated by the service provider or on behalf of the service provider. Connections 1221 and 1222 between telecommunication network 1210 and host computer 1230 may extend directly from core network 1214 to host computer 1230 or may go via an optional intermediate network 1220. Intermediate network 1220 may be one of, or a combination of more than one of, a public, private or hosted network; intermediate network 1220, if any, may be a backbone network or the Internet; in particular, intermediate network 1220 may comprise two or more sub-networks (not shown).

The communication system of FIG. 12 as a whole enables connectivity between the connected UEs 1291, 1292 and host computer 1230. The connectivity may be described as an over-the-top (OTT) connection 1250. Host computer 1230 and the connected UEs 1291, 1292 are configured to communicate data and/or signaling via OTT connection 1250, using access network 1211, core network 1214, any intermediate network 1220 and possible further infrastructure (not shown) as intermediaries. OTT connection 1250 may be transparent in the sense that the participating communication devices through which OTT connection 1250 passes are unaware of routing of uplink and downlink communications. For example, base station 1212 may not or need not be informed about the past routing of an incoming downlink communication with data originating from host computer 1230 to be forwarded (e.g., handed over) to a connected UE 1291. Similarly, base station 1212 need not be aware of the future routing of an outgoing uplink communication originating from the UE 1291 towards the host computer 1230.

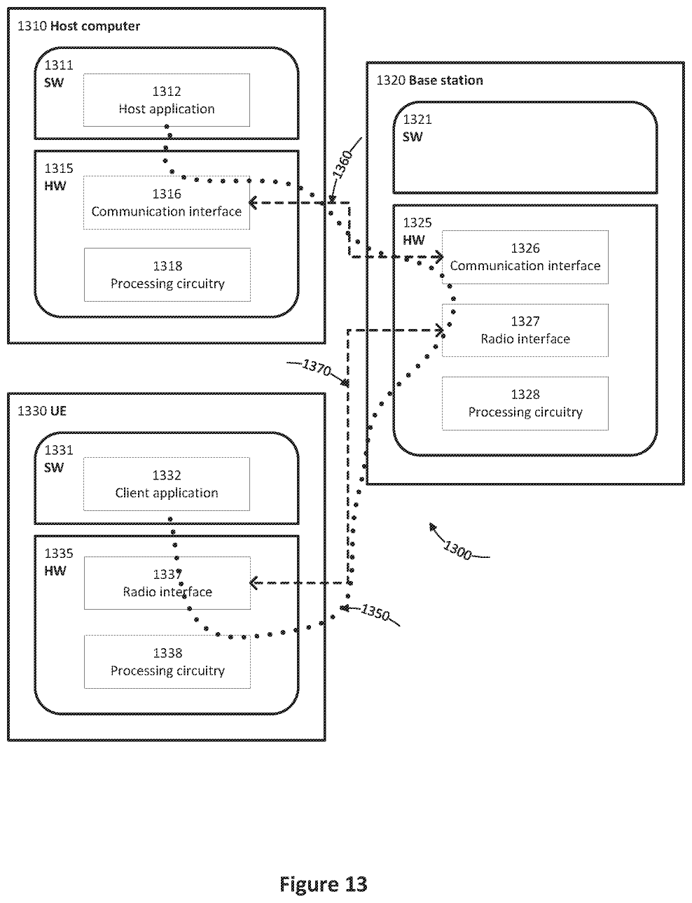

Example implementations, in accordance with an embodiment, of the UE, base station and host computer discussed in the preceding paragraphs will now be described with reference to FIG. 13. FIG. 13 illustrates host computer communicating via a base station with a user equipment over a partially wireless connection in accordance with some embodiments In communication system 1300, host computer 1310 comprises hardware 1315 including communication interface 1316 configured to set up and maintain a wired or wireless connection with an interface of a different communication device of communication system 1300. Host computer 1310 further comprises processing circuitry 1318, which may have storage and/or processing capabilities. In particular, processing circuitry 1318 may comprise one or more programmable processors, application-specific integrated circuits, field programmable gate arrays or combinations of these (not shown) adapted to execute instructions. Host computer 1310 further comprises software 1311, which is stored in or accessible by host computer 1310 and executable by processing circuitry 1318. Software 1311 includes host application 1312. Host application 1312 may be operable to provide a service to a remote user, such as UE 1330 connecting via OTT connection 1350 terminating at UE 1330 and host computer 1310. In providing the service to the remote user, host application 1312 may provide user data which is transmitted using OTT connection 1350.

Communication system 1300 further includes base station 1320 provided in a telecommunication system and comprising hardware 1325 enabling it to communicate with host computer 1310 and with UE 1330. Hardware 1325 may include communication interface 1326 for setting up and maintaining a wired or wireless connection with an interface of a different communication device of communication system 1300, as well as radio interface 1327 for setting up and maintaining at least wireless connection 1370 with UE 1330 located in a coverage area (not shown in FIG. 13) served by base station 1320. Communication interface 1326 may be configured to facilitate connection 1360 to host computer 1310. Connection 1360 may be direct or it may pass through a core network (not shown in FIG. 13) of the telecommunication system and/or through one or more intermediate networks outside the telecommunication system. In the embodiment shown, hardware 1325 of base station 1320 further includes processing circuitry 1328, which may comprise one or more programmable processors, application-specific integrated circuits, field programmable gate arrays or combinations of these (not shown) adapted to execute instructions. Base station 1320 further has software 1321 stored internally or accessible via an external connection.

Communication system 1300 further includes UE 1330 already referred to. Its hardware 1335 may include radio interface 1337 configured to set up and maintain wireless connection 1370 with a base station serving a coverage area in which UE 1330 is currently located. Hardware 1335 of UE 1330 further includes processing circuitry 1338, which may comprise one or more programmable processors, application-specific integrated circuits, field programmable gate arrays or combinations of these (not shown) adapted to execute instructions. UE 1330 further comprises software 1331, which is stored in or accessible by UE 1330 and executable by processing circuitry 1338. Software 1331 includes client application 1332. Client application 1332 may be operable to provide a service to a human or non-human user via UE 1330, with the support of host computer 1310. In host computer 1310, an executing host application 1312 may communicate with the executing client application 1332 via OTT connection 1350 terminating at UE 1330 and host computer 1310. In providing the service to the user, client application 1332 may receive request data from host application 1312 and provide user data in response to the request data. OTT connection 1350 may transfer both the request data and the user data. Client application 1332 may interact with the user to generate the user data that it provides.

It is noted that host computer 1310, base station 1320 and UE 1330 illustrated in FIG. 13 may be similar or identical to host computer 1230, one of base stations 1212a, 1212b, 1212c and one of UEs 1291, 1292 of FIG. 12, respectively. This is to say, the inner workings of these entities may be as shown in FIG. 13 and independently, the surrounding network topology may be that of FIG. 12.

In FIG. 13, OTT connection 1350 has been drawn abstractly to illustrate the communication between host computer 1310 and UE 1330 via base station 1320, without explicit reference to any intermediary devices and the precise routing of messages via these devices. Network infrastructure may determine the routing, which it may be configured to hide from UE 1330 or from the service provider operating host computer 1310, or both. While OTT connection 1350 is active, the network infrastructure may further take decisions by which it dynamically changes the routing (e.g., on the basis of load balancing consideration or reconfiguration of the network).

Wireless connection 1370 between UE 1330 and base station 1320 is in accordance with the teachings of the embodiments described throughout this disclosure. One or more of the various embodiments improve the performance of OTT services provided to UE 1330 using OTT connection 1350, in which wireless connection 1370 forms the last segment. More precisely, the teachings of these embodiments may improve the data rate, latency, power consumption, and general performance of the network, and thereby provide benefits such as reduced user waiting timer, relaxed restriction of file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 1350 between host computer 1310 and UE 1330, in response to variations in the measurement results. The measurement procedure and/or the network functionality for reconfiguring OTT connection 1350 may be implemented in software 1311 and hardware 1315 of host computer 1310 or in software 1331 and hardware 1335 of UE 1330, or both. In embodiments, sensors (not shown) may be deployed in or in association with communication devices through which OTT connection 1350 passes; the sensors may participate in the measurement procedure by supplying values of the monitored quantities exemplified above, or supplying values of other physical quantities from which software 1311, 1331 may compute or estimate the monitored quantities. The reconfiguring of OTT connection 1350 may include message format, retransmission settings, preferred routing etc.; the reconfiguring need not affect base station 1320, and it may be unknown or imperceptible to base station 1320. Such procedures and functionalities may be known and practiced in the art. In certain embodiments, measurements may involve proprietary UE signaling facilitating host computer 1310's measurements of throughput, propagation times, latency and the like. The measurements may be implemented in that software 1311 and 1331 causes messages to be transmitted, in particular empty or ‘dummy’ messages, using OTT connection 1350 while it monitors propagation times, errors etc.

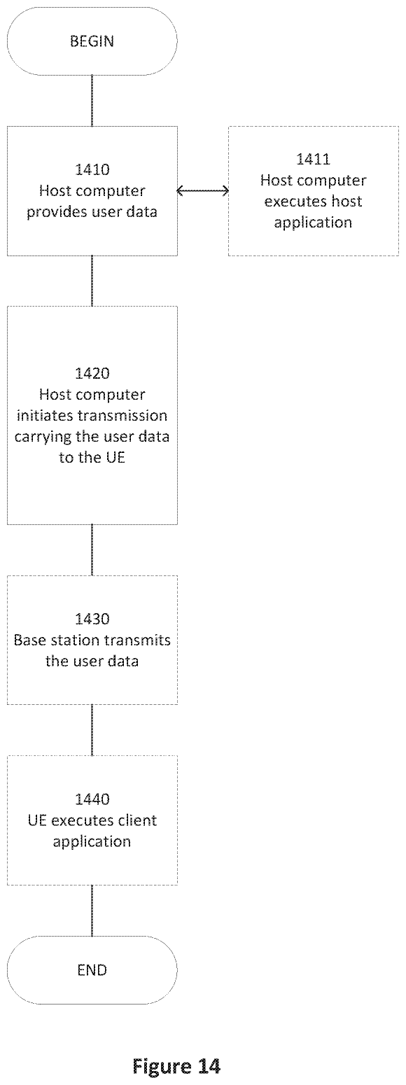

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 1410, the host computer provides user data. In substep 1411 (which may be optional) of step 1410, the host computer provides the user data by executing a host application. In step 1420, the host computer initiates a transmission carrying the user data to the UE. In step 1430 (which may be optional), the base station transmits to the UE the user data which was carried in the transmission that the host computer initiated, in accordance with the teachings of the embodiments described throughout this disclosure. In step 1440 (which may also be optional), the UE executes a client application associated with the host application executed by the host computer.

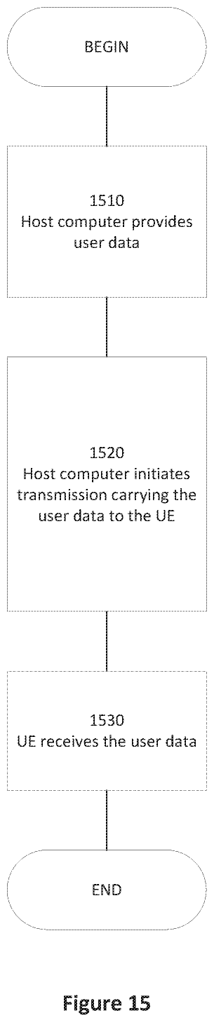

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 1510 of the method, the host computer provides user data. In an optional substep (not shown) the host computer provides the user data by executing a host application. In step 1520, the host computer initiates a transmission carrying the user data to the UE. The transmission may pass via the base station, in accordance with the teachings of the embodiments described throughout this disclosure. In step 1530 (which may be optional), the UE receives the user data carried in the transmission.

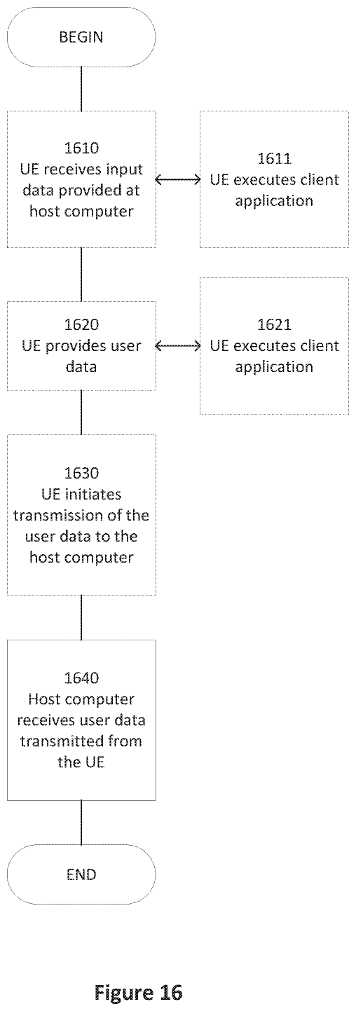

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 1610 (which may be optional), the UE receives input data provided by the host computer. Additionally or alternatively, in step 1620, the UE provides user data. In substep 1621 (which may be optional) of step 1620, the UE provides the user data by executing a client application. In substep 1611 (which may be optional) of step 1610, the UE executes a client application which provides the user data in reaction to the received input data provided by the host computer. In providing the user data, the executed client application may further consider user input received from the user. Regardless of the specific manner in which the user data was provided, the UE initiates, in substep 1630 (which may be optional), transmission of the user data to the host computer. In step 1640 of the method, the host computer receives the user data transmitted from the UE, in accordance with the teachings of the embodiments described throughout this disclosure.

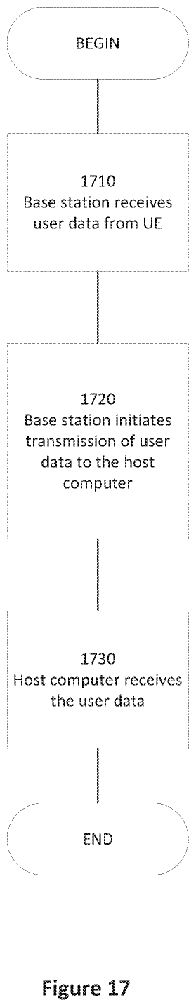

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 1710 (which may be optional), in accordance with the teachings of the embodiments described throughout this disclosure, the base station receives user data from the UE. In step 1720 (which may be optional), the base station initiates transmission of the received user data to the host computer. In step 1730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Other Embodiments Herein Include Those Enumerated Below in Groups A-D.

### Group A Embodiments

1. A method performed by a wireless device configured for use in a wireless communication network, the method comprising: receiving from the wireless communication network information that configures the wireless device to restrict access by the wireless device to the wireless communication network.

2. The method of embodiment 1, wherein the information semi-statically configures the wireless device to restrict access by the wireless device to the wireless communication network.

3. The method of any of embodiments 1-2, wherein the information configures the wireless device to restrict access by the wireless device to the wireless communication network indefinitely (i.e., for an indefinite time period).

4. The method of any of embodiments 1-3, wherein the information configures the wireless device to restrict access by the wireless device to the wireless communication network, unless and until the wireless device is configured otherwise by other information from the wireless communication network.

5. The method of any of embodiments 1-2, wherein the information configures the wireless device to restrict access by the wireless device to the wireless communication network for a defined time period.

6. The method of embodiment 5, wherein the defined time period is one of: a number of hours, a number of days, a number of weeks, a number of months, or a number of years.

7. The method of embodiment 1, wherein the information permanently configures the wireless device to restrict access by the wireless device to the wireless communication network.

8. The method of any of embodiments 1-7, wherein the information configures the wireless device as an obsolete device (whose purpose has become obsolete) that must restrict its access to the wireless communication network.

9. The method of any of embodiments 1-8, wherein the information configures the wireless device to restrict access to the wireless communication network by configuring the wireless device to belong to a certain access class.

10. The method of embodiment 9, wherein the access class is permanently restricted from accessing the wireless communication network in accordance with predefined rules or restrictions.

11. The method of any of embodiments 1-10, wherein the information comprises subscription information that configures an integrated circuit card or subscriber identity module of the wireless device such that the wireless device restricts access to the wireless communication network.

12. The method of embodiment 11, wherein the subscription information configures a protected file on the integrated circuit card or subscriber identity module.

13. The method of embodiment 11, wherein the subscription information deletes a file on the integrated circuit card or subscriber identity module.

14. The method of any of embodiments 1-13, wherein the information is received via dedicated signalling.

15. The method of any of embodiments 1-13, wherein the information is received via radio resource control (RRC) or medium access control (MAC) signalling.

16. The method of any of embodiments 1-15, wherein the information configures the wireless device via a sticky RRC or MAC configuration that remains valid after the wireless device is released to RRC idle mode.

17. The method of any of embodiments 1-15, wherein the information is received via non-access stratum (NAS) signalling.

18. The method of any of embodiments 1-17, wherein the information configures a capability of the wireless device.

19. The method of any of embodiments 1-18, wherein the information assigns the wireless device to a category of wireless devices that have become obsolete.

20. The method of embodiment 19, further comprising indicating in an attach request or a connection request an establishment cause that signals the wireless device belong to a category of wireless devices that have become obsolete.

21. The method of any of embodiments 1-19, wherein the information assigns the wireless device a new home public land mobile network to which access is restricted.

22. The method of any of embodiments 1-17, wherein the information is indicated in an information field that has multiple possible values, wherein one possible value indicates the wireless device is not allowed to access the wireless communication network until the wireless device receives an indication otherwise.

23. The method of embodiment 22, wherein another possible value indicates the wireless device is allowed to access the wireless communication network for a certain period of time.

24. The method of embodiment 23, wherein the certain period of time is a certain number of weeks or months.

25. The method of any of embodiments 1-24, wherein the information configures the wireless device to restrict both downlink and uplink access to the wireless communication network.

26. The method of any of embodiments 1-25, wherein the information configures the wireless device to switch to operating in a mode in which the wireless device is configured to restrict both downlink and uplink access to the wireless communication network.

27. The method of embodiment 26, wherein in the mode the wireless device is configured to restrict downlink access to the wireless communication network to occur only during certain periods or under certain conditions.

28. The method of embodiment 27, wherein the certain conditions include an emergency condition.

29. The method of any of embodiments 27-28, wherein in the mode the wireless device is configured to sleep for a period that is a number of weeks or months.

30. The method of any of embodiments 27-29, wherein in the mode the wireless device is configured to suspend one or more of: RRC idle mode tasks, mobile originated connection attempts, non-access stratum (NAS) signalling and/or data, and access-stratum (AS) signalling and/or data.

31. The method of any of embodiments 1-25, wherein the information configures the wireless device to restrict uplink access to the wireless communication network, but not downlink access to the wireless communication network.

32. The method of any of embodiments 1-25 and 31, wherein the information configures the wireless device to restrict device-initiated uplink access to the wireless communication network, but not downlink access to the wireless communication network and not network-initiated uplink access to the wireless communication network.

33. The method of any of embodiments 1-25 and 31-32, wherein as configured according to the information the wireless device is not allowed to initiate establishment or resumption of a radio resource control, RRC, connection to the wireless communication network.

34. The method of any of embodiments 1-25 and 31-33, wherein as configured according to the information the wireless device is not allowed to initiate any procedure that triggers establishment or resumption of a radio resource control, RRC, connection to the wireless communication network.

35. The method of any of embodiments 31-34, further comprising attaching to the wireless communication network and, while the wireless device is attached to the wireless communication network and configured to restrict access to the wireless communication network, monitoring for a page from the wireless communication network and/or receiving a downlink transmission from the wireless communication network.

36. The method of any of embodiments 31-35, further comprising, while the wireless device is configured to restrict access to the wireless communication network, receiving an update to an application of the wireless communication device or an update to firmware of the wireless communication device.

37. The method of embodiment 36, further comprising, responsive to receiving the update, configuring the wireless communication device to no longer restrict access to the wireless communication network according to the information.

38. The method of any of embodiments 1-37, further comprising configuring the wireless device to restrict access to the wireless communication network according to the received information.

39. The method of any of embodiments 1-38, further comprising restricting access to the wireless communication network according to the information.

40. The method of embodiment 39, wherein said restricting comprises refraining from accessing the wireless communication network.

41. The method of embodiment 40, wherein said refraining comprises refraining from accessing the wireless communication network for an indefinite time period or for a period that is a number of weeks or months.

42. The method of any of embodiments 1-41, wherein the wireless communication network is a home network of the wireless communication device.

42A. The method of any of embodiments 1-42, wherein the wireless device is a user equipment.

42B. The method of any of embodiments 1-42, wherein the wireless device is a machine type communication (MTC) device or a narrowband internet of things (NB-IoT) device.

43. A method performed by a wireless device configured for use in a wireless communication network, the method comprising: configuring the wireless device to restrict access by the wireless device to the wireless communication network.

AA. The method of any of the previous embodiments, further comprising: providing user data; and forwarding the user data to a host computer via the transmission to the base station.

### Group B Embodiments

44. A method performed by a network node configured for use in a wireless communication network, the method comprising: transmitting from the wireless communication network information that configures a wireless device to restrict access by the wireless device to the wireless communication network.

45. The method of embodiment 44, wherein the information semi-statically configures the wireless device to restrict access by the wireless device to the wireless communication network.

46. The method of any of embodiments 44-45, wherein the information configures the wireless device to restrict access by the wireless device to the wireless communication network indefinitely (i.e., for an indefinite time period).

47. The method of any of embodiments 44-46, wherein the information configures the wireless device to restrict access by the wireless device to the wireless communication network, unless and until the wireless device is configured otherwise by other information from the wireless communication network.

48. The method of any of embodiments 44-45, wherein the information configures the wireless device to restrict access by the wireless device to the wireless communication network for a defined time period.

49. The method of embodiment 48, wherein the defined time period is one of: a number of hours, a number of days, a number of weeks, a number of months, or a number of years.

50. The method of embodiment 44, wherein the information permanently configures the wireless device to restrict access by the wireless device to the wireless communication network.

51. The method of any of embodiments 44-50, wherein the information configures the wireless device as an obsolete device (whose purpose has become obsolete) that must restrict its access to the wireless communication network.

52. The method of any of embodiments 44-51, wherein the information configures the wireless device to restrict access to the wireless communication network by configuring the wireless device to belong to a certain access class.

53. The method of embodiment 52, wherein the access class is permanently restricted from accessing the wireless communication network in accordance with predefined rules or restrictions.

54. The method of any of embodiments 44-54, wherein the information comprises subscription information that configures an integrated circuit card or subscriber identity module of the wireless device such that the wireless device restricts access to the wireless communication network.

55. The method of embodiment 54, wherein the subscription information configures a protected file on the integrated circuit card or subscriber identity module.

56. The method of embodiment 54, wherein the subscription information deletes a file on the integrated circuit card or subscriber identity module.

57. The method of any of embodiments 44-56, wherein the information is transmitting via dedicated signalling.

58. The method of any of embodiments 44-57, wherein the information is transmitting via radio resource control (RRC) or medium access control (MAC) signalling.

59. The method of any of embodiments 44-58, wherein the information configures the wireless device via a sticky RRC or MAC configuration that remains valid after the wireless device is released to RRC idle mode.

60. The method of any of embodiments 44-58, wherein the information is transmitting via non-access stratum (NAS) signalling.

61. The method of any of embodiments 44-60, wherein the information configures a capability of the wireless device.

62. The method of any of embodiments 44-61, wherein the information assigns the wireless device to a category of wireless devices that have become obsolete.

63. The method of embodiment 62, further comprising receiving an indication in an attach request or a connection request an establishment cause that signals the wireless device belongs to a category of wireless devices that have become obsolete.

64. The method of any of embodiments 44-63, wherein the information assigns the wireless device a new home public land mobile network to which access is restricted.

65. The method of any of embodiments 44-60, wherein the information is indicated in an information field that has multiple possible values, wherein one possible value indicates the wireless device is not allowed to access the wireless communication network until the wireless device receives an indication otherwise.

66. The method of embodiment 65, wherein another possible value indicates the wireless device is allowed to access the wireless communication network for a certain period of time.

67. The method of embodiment 66, wherein the certain period of time is a certain number of weeks or months.

68. The method of any of embodiments 44-67, wherein the information configures the wireless device to restrict both downlink and uplink access to the wireless communication network.

69. The method of any of embodiments 44-68, wherein the information configures the wireless device to switch to operating in a mode in which the wireless device is configured to restrict both downlink and uplink access to the wireless communication network.

70. The method of embodiment 69, wherein in the mode the wireless device is configured to restrict downlink access to the wireless communication network to occur only during certain periods or under certain conditions.

71. The method of embodiment 70, wherein the certain conditions include an emergency condition.

72. The method of any of embodiments 70-71, wherein in the mode the wireless device is configured to sleep for a period that is a number of weeks or months.

73. The method of any of embodiments 70-72, wherein in the mode the wireless device is configured to suspend one or more of: RRC idle mode tasks, mobile originated connection attempts, non-access stratum (NAS) signalling and/or data, and access-stratum (AS) signalling and/or data.

74. The method of any of embodiments 44-68, wherein the information configures the wireless device to restrict uplink access to the wireless communication network, but not downlink access to the wireless communication network.

75. The method of any of embodiments 44-68 and 74, wherein the information configures the wireless device to restrict device-initiated uplink access to the wireless communication network, but not downlink access to the wireless communication network and not network-initiated uplink access to the wireless communication network.

76. The method of any of embodiments 44-68 and 74-75, wherein as configured according to the information the wireless device is not allowed to initiate establishment or resumption of a radio resource control, RRC, connection to the wireless communication network.

77. The method of any of embodiments 44-68 and 74-76, wherein as configured according to the information the wireless device is not allowed to initiate any procedure that triggers establishment or resumption of a radio resource control, RRC, connection to the wireless communication network.

78. The method of any of embodiments 74-77, further comprising, while the wireless device is attached to the wireless communication network and configured to restrict access to the wireless communication network, transmitting a page from the wireless communication network to the wireless device and/or transmitting a downlink transmission from the wireless communication network to the wireless device.

79. The method of any of embodiments 74-78, further comprising, while the wireless device is configured to restrict access to the wireless communication network, transmitting an update to an application of the wireless communication device or an update to firmware of the wireless communication device.

80. The method of embodiment 79, further comprising, responsive to or along with transmitting the update, configuring the wireless communication device to no longer restrict access to the wireless communication network according to the information.

81. The method of any of embodiments 44-80, further comprising determining to restrict access by the wireless device to the wireless communication network and transmitting the information responsive to the determining.

82. The method of embodiment 81, wherein said determining is based on the wireless device not having successfully set up a connection or attach to the wireless communication network for a certain period of time or over a certain number of attempts.

83. The method of any of embodiments 81-82, wherein said determining is based on the wireless device engaging in one or more actions indicating misconduct by the wireless device.

84. The method of any of embodiments 81-83, wherein said determining is based on receiving from the wireless device signalling from a certain application (e.g., that is deemed obsolete).

85. The method of any of embodiments 81-84, wherein said determining is based on not having receiving any signalling or any application layer signalling from the wireless device for a certain time period.

86. The method of any of embodiments 44-85, wherein the wireless communication network is a home network of the wireless communication device.

87. The method of any of embodiments 44-86, wherein the network node is a radio network node.

88. The method of embodiment 87, wherein the radio network node is a base station.

89. The method of any of embodiments 44-86, wherein the network node is a core network node.

86. A method performed by a network node configured for use in a wireless communication network, the method comprising: configuring a wireless device to restrict access by the wireless device to the wireless communication network.

BB. The method of any of the previous embodiments, further comprising: obtaining user data; and forwarding the user data to a host computer or a wireless device.

### Group C Embodiments

C1. A wireless device configured to perform any of the steps of any of the Group A embodiments.

C2. A wireless device comprising: processing circuitry configured to perform any of the steps of any of the Group A embodiments; and power supply circuitry configured to supply power to the wireless device.

C3. A wireless device comprising: processing circuitry and memory, the memory containing instructions executable by the processing circuitry whereby the wireless device is configured to perform any of the steps of any of the Group A embodiments.

C4. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

C5. A computer program comprising instructions which, when executed by at least one processor of a wireless device, causes the wireless device to carry out the steps of any of the Group A embodiments.

C6. A carrier containing the computer program of embodiment C5, wherein the carrier is one of an electronic signal, optical signal, radio signal, or computer readable storage medium.

C7. A network node configured to perform any of the steps of any of the Group B embodiments.

C8. A network node comprising: processing circuitry configured to perform any of the steps of any of the Group B embodiments; power supply circuitry configured to supply power to the network node.

C9. A network node comprising: processing circuitry and memory, the memory containing instructions executable by the processing circuitry whereby the network node is configured to perform any of the steps of any of the Group B embodiments.

C10. A computer program comprising instructions which, when executed by at least one processor of a network node, causes the network node to carry out the steps of any of the Group B embodiments.

C11. A carrier containing the computer program of embodiment C10, wherein the carrier is one of an electronic signal, optical signal, radio signal, or computer readable storage medium.

### Group D Embodiments

D1. A communication system including a host computer comprising: processing circuitry configured to provide user data; and a communication interface configured to forward the user data to a cellular network for transmission to a user equipment (UE), wherein the cellular network comprises a base station having a radio interface and processing circuitry, the base station's processing circuitry configured to perform any of the steps of any of the Group B embodiments.

D2. The communication system of the previous embodiment further including the base station.

D3. The communication system of the previous 2 embodiments, further including the UE, wherein the UE is configured to communicate with the base station.

D4. The communication system of the previous 3 embodiments, wherein: the processing circuitry of the host computer is configured to execute a host application, thereby providing the user data; and the UE comprises processing circuitry configured to execute a client application associated with the host application.

D5. A method implemented in a communication system including a host computer, a base station and a user equipment (UE), the method comprising: at the host computer, providing user data; and at the host computer, initiating a transmission carrying the user data to the UE via a cellular network comprising the base station, wherein the base station performs any of the steps of any of the Group B embodiments.

D6. The method of the previous embodiment, further comprising, at the base station, transmitting the user data.

D7. The method of the previous 2 embodiments, wherein the user data is provided at the host computer by executing a host application, the method further comprising, at the UE, executing a client application associated with the host application.

D8. A user equipment (UE) configured to communicate with a base station, the UE comprising a radio interface and processing circuitry configured to perform any of the previous 3 embodiments.

D9. A communication system including a host computer comprising: processing circuitry configured to provide user data; and a communication interface configured to forward user data to a cellular network for transmission to a user equipment (UE), wherein the UE comprises a radio interface and processing circuitry, the UE's components configured to perform any of the steps of any of the Group A embodiments.

D10. The communication system of the previous embodiment, wherein the cellular network further includes a base station configured to communicate with the UE.

D11. The communication system of the previous 2 embodiments, wherein: the processing circuitry of the host computer is configured to execute a host application, thereby providing the user data; and the UE's processing circuitry is configured to execute a client application associated with the host application.

D12. A method implemented in a communication system including a host computer, a base station and a user equipment (UE), the method comprising: at the host computer, providing user data; and at the host computer, initiating a transmission carrying the user data to the UE via a cellular network comprising the base station, wherein the UE performs any of the steps of any of the Group A embodiments.

D13. The method of the previous embodiment, further comprising at the UE, receiving the user data from the base station.

D14. A communication system including a host computer comprising: communication interface configured to receive user data originating from a transmission from a user equipment (UE) to a base station, wherein the UE comprises a radio interface and processing circuitry, the UE's processing circuitry configured to perform any of the steps of any of the Group A embodiments.

D15. The communication system of the previous embodiment, further including the UE.

D16. The communication system of the previous 2 embodiments, further including the base station, wherein the base station comprises a radio interface configured to communicate with the UE and a communication interface configured to forward to the host computer the user data carried by a transmission from the UE to the base station.

D17. The communication system of the previous 3 embodiments, wherein: the processing circuitry of the host computer is configured to execute a host application; and the UE's processing circuitry is configured to execute a client application associated with the host application, thereby providing the user data.

D18. The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

D19. A method implemented in a communication system including a host computer, a base station and a user equipment (UE), the method comprising: at the host computer, receiving user data transmitted to the base station from the UE, wherein the UE performs any of the steps of any of the Group A embodiments.

D20. The method of the previous embodiment, further comprising, at the UE, providing the user data to the base station.

D21. The method of the previous 2 embodiments, further comprising: at the UE, executing a client application, thereby providing the user data to be transmitted; and at the host computer, executing a host application associated with the client application.

D22. The method of the previous 3 embodiments, further comprising: at the UE, executing a client application; and at the UE, receiving input data to the client application, the input data being provided at the host computer by executing a host application associated with the client application, wherein the user data to be transmitted is provided by the client application in response to the input data.

D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

D24. The communication system of the previous embodiment further including the base station.

D25. The communication system of the previous 2 embodiments, further including the UE, wherein the UE is configured to communicate with the base station.

D26. The communication system of the previous 3 embodiments, wherein: the processing circuitry of the host computer is configured to execute a host application; the UE is configured to execute a client application associated with the host application, thereby providing the user data to be received by the host computer.

D27. A method implemented in a communication system including a host computer, a base station and a user equipment (UE), the method comprising: at the host computer, receiving, from the base station, user data originating from a transmission which the base station has received from the UE, wherein the UE performs any of the steps of any of the Group A embodiments.

D28. The method of the previous embodiment, further comprising at the base station, receiving the user data from the UE.

D29. The method of the previous 2 embodiments, further comprising at the base station, initiating a transmission of the received user data to the host computer.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1-29. (canceled)

30. A method performed by a wireless device configured for use in a wireless communication network, the method comprising the wireless device:
receiving, from the wireless communication network, information that configures the wireless device to restrict uplink access by the wireless device to the wireless communication network, unless and until the wireless device is configured otherwise by other information from the wireless communication network; and
restricting uplink access by the wireless device to the wireless communication network in accordance with the received information.

31. The method of claim 30, wherein the information is received via dedicated signaling.

32. The method of claim 30, further comprising:
attaching to the wireless communication network; and
while the wireless device is attached to the wireless communication network and configured to restrict uplink access to the wireless communication network, monitoring for a page from the wireless communication network and/or receiving a downlink transmission from the wireless communication network.

33. The method of claim 30, further comprising, while the wireless device is configured to restrict uplink access to the wireless communication network, receiving an update to an application of the wireless communication device or an update to firmware of the wireless communication device.

34. A method performed by a network node configured for use in a wireless communication network, the method comprising the network node:
transmitting, from the wireless communication network, information that configures a wireless device to restrict uplink access by the wireless device to the wireless communication network, unless and until the wireless device is configured otherwise by other information from the wireless communication network.

35. The method of claim 34, wherein the information is transmitted via dedicated signaling.

36. The method of claim 34, further comprising, while the wireless device is attached to the wireless communication network and configured to restrict access to the wireless communication network, transmitting a page from the wireless communication network to the wireless device and/or transmitting a downlink transmission from the wireless communication network to the wireless device.

37. The method of claim 34, further comprising, while the wireless device is configured to restrict access to the wireless communication network, transmitting an update to an application of the wireless communication device or an update to firmware of the wireless communication device.

38. The method of claim 34, further comprising:
determining to restrict access by the wireless device to the wireless communication network; and
transmitting the information responsive to the determining.

39. The method of claim 38, wherein the determining is based on:
the wireless device not having successfully set up a connection or attached to the wireless communication network for a certain period of time or over a certain number of attempts;
the wireless device engaging in one or more actions indicating misconduct by the wireless device;
receiving from the wireless device signaling from a certain application; and/or
not having received any application layer signaling from the wireless device for a certain time period.

40. The method of claim 30, wherein the information indicates uplink access by the wireless device to the wireless communication network is not allowed.

41. The method of claim 30, wherein the information indicates the wireless device is barred from uplink access to the wireless communication network.

42. The method of claim 30, wherein the information configures the wireless device to restrict uplink access to the wireless communication network, but not downlink access to the wireless communication network.

43. The method of claim 30, wherein the other information includes a page from the wireless communication network.

44. The method of claim 30, wherein the information configures the wireless device to restrict uplink access to the wireless communication network by configuring the wireless device to belong to a certain access class.

45. The method of claim 30, wherein the information assigns the wireless device to a category of wireless devices that have become obsolete, configures a capability of the wireless device, assigns the wireless device a new home public land mobile network to which access is restricted, or comprises subscription information that configures an integrated circuit card or subscriber identity module of the wireless device such that the wireless device restricts uplink access to the wireless communication network.

46. The method of claim 30, wherein, as configured according to the information, the wireless device is not allowed to:
initiate establishment or resumption of a radio resource control (RRC) connection to the wireless communication network; or
initiate any procedure that triggers establishment or resumption of an RRC connection to the wireless communication network.

47. The method of claim 30, wherein the wireless device is a machine type communication (MTC) device or a narrowband internet of things (NB-IoT) device.

48. A wireless device configured for use in a wireless communication network, the wireless device comprising:
communication circuitry; and
processing circuitry configured to:
receive, from the wireless communication network and via the communication circuitry, information that configures the wireless device to restrict uplink access by the wireless device to the wireless communication network, unless and until the wireless device is configured otherwise by other information from the wireless communication network; and
restrict uplink access by the wireless device to the wireless communication network in accordance with the received information.

49. A network node configured for use in a wireless communication network, the network node comprising:
communication circuitry; and
processing circuitry configured to transmit, via the communication circuitry, information that configures a wireless device to restrict uplink access by the wireless device to the wireless communication network, unless and until the wireless device is configured otherwise by other information from the wireless communication network.
